(19) United States
(12) Patent Application Publication
(10) Pub. No.: US 2026/0164503 A1
(43) Pub. Date: Jun. 11, 2026

(54) METHOD AND APPARATUS FOR BEAM INDICATION CONSIDERING SIGNAL AND INTERFERENCE IN COMMUNICATION SYSTEM

(71) Applicant: Electronics and Telecommunications Research Institute, Daejeon (KR)

(72) Inventors: Cheulsoon KIM, Daejeon (KR); Ji Hyung KIM, Daejeon (KR); Sung-Hyun MOON, Daejeon (KR); Junghoon LEE, Daejeon (KR); Hoiyoon JUNG, Daejeon (KR)

(21) Appl. No.: 19/412,679

(22) Filed: Dec. 8, 2025

(30) Foreign Application Priority Data
Dec. 6, 2024 (KR) 10-2024-0180627
Nov. 6, 2025 (KR) 10-2025-0166508
Dec. 4, 2025 (KR) 10-2025-0190832

(51) Int. Cl. H04W 76/28; H04W 72/1273; H04W 72/232

(52) U.S. Cl. CPC H04W 76/28; H04W 72/1273; H04W 72/232

(57) ABSTRACT

A method of a terminal may comprise: receiving, from a base station, transmission and reception point (TRP) discontinuous transmission (DTX) configuration information; receiving, from the base station, activation information indicating activation of a TRP DTX operation based on the TRP DTX configuration information; and performing communication with one or more TRPs associated with the base station based on the TRP DTX operation being activated.

### CROSS-REFERENCE TO RELATED APPLICATIONS

This application claims priority to Korean Patent Applications No. 10-2024-0180627, filed on Dec. 6, 2024, No. 10-2025-0166508, filed on Nov. 6, 2025, and No. 10-2025-0190832, filed on Dec. 4, 2025, with the Korean Intellectual Property Office (KIPO), the entire contents of which are hereby incorporated by reference.

### BACKGROUND

### 1. Technical Field

The present disclosure relates to a communication technique, and more particularly, to a beam indication technique for a multi-transmission and reception point (TRP) system based on multiple antennas.

### 2. Related Art

Meanwhile, alongside the advancement of information and communication technologies, various wireless communication technologies are being developed. The representative wireless communication technologies may encompass long term evolution (LTE) and new radio (NR) as specified in the 3rd Generation Partnership Project (3GPP) standards. The LTE may be one of the wireless communication technologies among fourth generation (4G) wireless communication technologies, while the NR may be one of the wireless communication technologies among fifth generation (5G) wireless communication technologies.

Following the commercialization of the 4G communication systems (e.g., communication systems supporting LTE), there is consideration for 5G communication systems (e.g., communication systems supporting NR) that utilize frequency bands (e.g., frequency bands above 6GHz) higher than those of the 4G communication systems, in addition to frequency bands (e.g., frequency bands below 6GHz) used by 4G communication systems, to address the increasing demand for wireless data processing. The 5G communication system can support enhanced Mobile BroadBand (eMBB), Ultra-Reliable and Low Latency Communication (URLLC) and massive Machine Communication (mMTC). Discussions are underway about the 6G communication system that will follow the 5G communication system.

Meanwhile, when a terminal is located at an edge of a coverage of a base station, communication quality between the terminal and the base station may be degraded. In this case, the terminal may fail to perform communication with the base station. Methods for solving the above-described problem are needed.

### SUMMARY

The present disclosure for resolving the above-described problems is directed to providing a method and an apparatus for beam indication considering signals and interferences in a communication system.

A method of a terminal, according to exemplary embodiments of the present disclosure, may comprise: receiving, from a base station, transmission and reception point (TRP) discontinuous transmission (DTX) configuration information; receiving, from the base station, activation information indicating activation of a TRP DTX operation based on the TRP DTX configuration information; and performing communication with one or more TRPs associated with the base station based on the TRP DTX operation being activated.

The activation information indicating the activation of the TRP DTX operation may be included in a medium access control (MAC) control element (CE) or first downlink control information (DCI) received from the base station.

The method may further comprise: receiving, from the base station, deactivation information indicating deactivation of the TRP DTX operation; and performing communication with the one or more TRPs associated with the base station based on the TRP DTX operation being deactivated.

The method may further comprise: receiving, from the base station, second DCI scheduling downlink (DL) transmission; determining at least one TRP for performing the DL transmission based on TRP indication information included in the second DCI and a TRP associated with the activated TRP DTX operation; and receiving the DL transmission from the at least one TRP associated with the base station.

The method may further comprise: receiving, from the base station, second DCI scheduling DL transmission; based on the DL transmission being performed before an application time of the activation information, determining at least one TRP for performing the DL transmission based on information indicating activation or deactivation of the TRP DTX operation received before the activation information and based on TRP indication information included in the second DCI; and receiving the DL transmission from the at least one TRP associated with the base station.

The method may further comprise: receiving, from the base station, second DCI scheduling DL transmission; determining at least one TRP for performing the DL transmission based on TRP indication information included in the second DCI regardless of whether the TRP DTX operation is activated; and receiving the DL transmission from the at least one TRP associated with the base station.

The method may further comprise: receiving, from the base station, information indicating switching of a TCI state indication scheme, wherein the TCI state indication scheme may be a joint TCI state indication scheme or a separate TCI state indication scheme.

The method may further comprise: receiving, from the base station, information indicating that dynamic switching of a TCI state indication scheme is enabled, wherein the TCI state indication scheme may be switched based on a state of the TRP DTX operation being changed to an activated state or a deactivated state, and the TCI state indication scheme may be a joint TCI state indication scheme or a separate TCI state indication scheme.

The joint TCI state indication scheme may be used based on the state of the TRP DTX operation being the activated state, and the separate TCI state indication scheme may be used based on the state of the TRP DTX operation being the deactivated state.

The method may further comprise: receiving, from the base station, TRP discontinuous reception (DRX) configuration information; receiving, from the base station, activation information indicating activation of a TRP DRX operation based on the TRP DRX configuration information; and performing communication with at least one TRP associated with the base station based on the TRP DRX operation being activated.

A terminal, according to exemplary embodiments of the present disclosure, may comprise: at least one processor, wherein the at least one processor may cause the terminal to perform: receiving, from a base station, transmission and reception point (TRP) discontinuous transmission (DTX) configuration information; receiving, from the base station, activation information indicating activation of a TRP DTX operation based on the TRP DTX configuration information; and performing communication with one or more TRPs associated with the base station based on the TRP DTX operation being activated.

The activation information indicating the activation of the TRP DTX operation may be included in a medium access control (MAC) control element (CE) or first downlink control information (DCI) received from the base station.

The at least one processor may further cause the terminal to perform: receiving, from the base station, deactivation information indicating deactivation of the TRP DTX operation; and performing communication with the one or more TRPs associated with the base station based on the TRP DTX operation being deactivated.

The at least one processor may further cause the terminal to perform: receiving, from the base station, second DCI scheduling downlink (DL) transmission; determining at least one TRP for performing the DL transmission based on TRP indication information included in the second DCI and a TRP associated with the activated TRP DTX operation; and receiving the DL transmission from the at least one TRP associated with the base station.

The at least one processor may further cause the terminal to perform: receiving, from the base station, second DCI scheduling DL transmission; based on the DL transmission being performed before an application time of the activation information, determining at least one TRP for performing the DL transmission based on information indicating activation or deactivation of the TRP DTX operation received before the activation information and based on TRP indication information included in the second DCI; and receiving the DL transmission from the at least one TRP associated with the base station.

The at least one processor may further cause the terminal to perform: receiving, from the base station, second DCI scheduling DL transmission; determining at least one TRP for performing the DL transmission based on TRP indication information included in the second DCI regardless of whether the TRP DTX operation is activated; and receiving the DL transmission from the at least one TRP associated with the base station.

The at least one processor may further cause the terminal to perform: receiving, from the base station, information indicating switching of a TCI state indication scheme, wherein the TCI state indication scheme may be a joint TCI state indication scheme or a separate TCI state indication scheme.

The at least one processor may further cause the terminal to perform: receiving, from the base station, information indicating that dynamic switching of a TCI state indication scheme is enabled, wherein the TCI state indication scheme may be switched based on a state of the TRP DTX operation being changed to an activated state or a deactivated state, and the TCI state indication scheme may be a joint TCI state indication scheme or a separate TCI state indication scheme.

The joint TCI state indication scheme may be used based on the state of the TRP DTX operation being the activated state, and the separate TCI state indication scheme may be used based on the state of the TRP DTX operation being the deactivated state.

The at least one processor may further cause the terminal to perform: receiving, from the base station, TRP discontinuous reception (DRX) configuration information; receiving, from the base station, activation information indicating activation of a TRP DRX operation based on the TRP DRX configuration information; and performing communication with at least one TRP associated with the base station based on the TRP DRX operation being activated.

According to the present disclosure, a TRP can perform a DTX operation and/or a DRX operation. When the TRP DTX operation and/or the TRP DRX operation is supported, energy can be saved in a network. A terminal can determine a TRP (e.g., beam or TCI) for performing communication (e.g., downlink (DL) transmission, uplink (UL) transmission) by considering a TRP DTX state (e.g., activated state or deactivated state) and/or a TRP DRX state (e.g., activated state or deactivated state), and the terminal can perform the communication based on the determined TRP. Since the TRP for communication with the terminal is determined by considering the TRP DTX state and/or the TRP DRX state, a problem of ambiguity for a TRP may not occur in a communication system supporting the TRP DTX operation and/or the TRP DRX operation. Accordingly, performance of the communication system can be improved.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating RxP operation of TRP1 supporting a DTX pattern.

FIG. 4 is a conceptual diagram illustrating TxP operation of TRP2 supporting a DRX pattern.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

In exemplary embodiments, ‘configuration of an operation (e.g., transmission operation)’ may mean ‘signaling of configuration information (e.g., information, information element(s), parameter(s)) for the operation’ and/or ‘signaling of information indicating performing of the operation’. ‘Configuration of information (e.g., information element(s), parameter(s))’ may mean that the corresponding information is signaled. The signaling may be at least one of system information (SI) signaling (e.g., transmission of system information block (SIB) and/or master information block (MIB)), radio resource control (RRC) signaling (e.g., transmission of RRC message(s), RRC parameter(s) and/or higher layer parameter(s)), MAC control element (CE) signaling (e.g., transmission of a MAC message and/or MAC CE), PHY signaling (e.g., transmission of a PHY message, downlink control information (DCI), uplink control information (UCI), and/or sidelink control information (SCI)), or a combination thereof.

The message for SI signaling may be referred to as an SI message, the message for RRC signaling may be referred to as an RRC message, the message for MAC CE signaling may be referred to as a MAC message, and the message for PHY signaling may be referred to as a PHY message. The aforementioned messages may be expressed as a first message, a second message, a third message, and so on.

In the present disclosure, an expression including “when ˜” may be expressed as an expression including “based on ˜” or an expression including “in response to ˜”. In other words, an expression including “when ˜” may be interpreted as being the same as or similar to an expression including “based on ˜” or an expression including “in response to ˜”.

In the present disclosure, “time” may refer to a “time point”, and a “time point” may refer to “time”. The terms “time” and “time point” may be used interchangeably. A reception time of a signal or channel may refer to a reception start time or a reception end time. A transmission time of a signal or channel may refer to a transmission start time or a transmission end time.

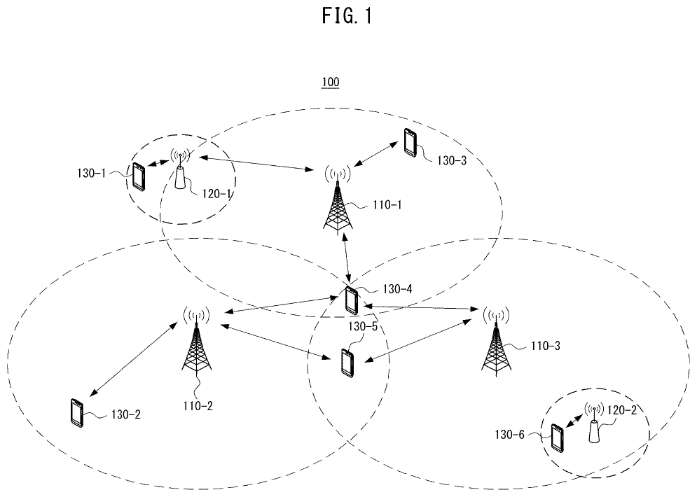

FIG. 1 is a conceptual diagram illustrating exemplary embodiments of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g., serving-gateway (S-GW), packet data network (PDN)-gateway (P-GW), and mobility management entity (MME)). When the communication system 100 is the 5G communication system (e.g., NR system), the core network may include an access and mobility management function (AMF), a user plane function (UPF), a session management function (SMF), and the like.

The plurality of communication nodes 110 to 130 may support the communication protocols (e.g., LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may have the following structure.

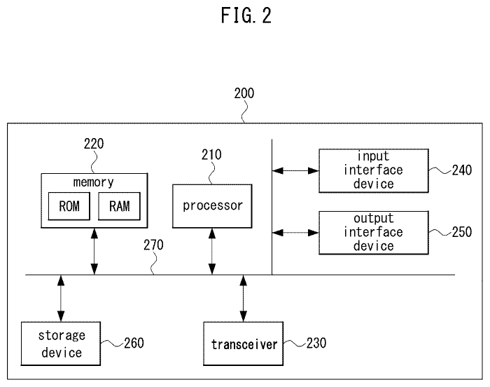

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication system will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

In order to reduce an error rate of data, a low modulation and coding scheme (MCS) level (or, low MCS index) may be applied. In order not to increase a size of a field indicated by downlink control information (DCI), frequently used MCS(s) may be selected. In order to apply a lower MCS, a repeated transmission operation may be supported. In case of applying a quadrature phase shift keying (QPSK) which is the lowest modulation rate, an effect of further reducing the code rate may occur. In particular, since a transmit power is limited in uplink (UL) transmission, the repeated transmission operation may be performed in the time domain rather than in the frequency domain.

In the case of eMBB traffic and URLLC traffic, a lower MCS may be used for different purposes, respectively. For example, for eMBB traffic, a lower MCS may be required to extend a coverage. On the other hand, for URLLC traffic, a lower MCS may be required to reduce a latency and achieve a lower error rate. Since the requirements are different, the eMBB traffic may be repeatedly transmitted even when a relatively large latency occurs. The URLLC traffic may be transmitted using new MCSs (e.g., low MCS) rather than the repeated transmission. The new MCS may be configured by an RRC message and/or a DCI.

In order to support repeated transmissions for the eMBB traffic in the time domain, a physical uplink shared channel (PUSCH) repetition (e.g., PUSCH repetition type A) may be introduced. In the present disclosure, a PUSCH repetition may mean a PUSCH instance. In other words, depending on the context, a PUSCH repetition may be interpreted as having the same meaning as a PUSCH instance. Repeated transmission of a PUSCH may be performed in units of PUSCH instances. When repeated transmission of a PUSCH is performed, a PUSCH allocated on a slot basis may be repeatedly transmitted. To extend a coverage, a time resource may be allocated over a plurality of slots. When the PUSCH repetition type A is used, the time resource may be configured by an RRC message and/or a DCI. The number of repetitions of the PUSCH may be indicated by the RRC message, and a time resource for transmitting the PUSCH in the first slot may be indicated by the DCI (e.g., in case of type 2 configured grant (CG) or dynamic grant) or the RRC message (e.g., in case of type 1 CG). In the present disclosure, the number of repetitions may mean the number of repeated transmissions or the number of transmissions.

Since a delay time occurs when URLLC traffic is transmitted repeatedly, it may not be appropriate to transmit URLLC traffic repeatedly. However, if a sufficiently low MCS is used, a delay in decoding URLLC traffic can be reduced. That is, when a sufficiently low MCS is used, the number of resource elements (REs) to which URLLC traffic is mapped may increase, and the base station (e.g., decoder of the base station) should wait until all the REs are received. In this case, a delay in decoding URLLC traffic may be reduced.

When a PUSCH with a somewhat high MCS applied is repeatedly transmitted, the base station may perform a decoding operation with only some REs. A time when decoding is succeeded first in repeated PUSCH transmission (e.g., repeated PUSCH transmission with a somewhat high MCS applied) may be earlier than a time when decoding is succeeded first in a PUSCH transmission without repetition (e.g., PUSCH transmission with a low MCS applied). When a PUSCH repetition type A is used, an unnecessary delay may occur, and thus a PUSCH repetition type B may be introduced to reduce a delay time due to repeated transmission. When the PUSCH repetition type B is used, a PUSCH allocated on a mini-slot basis may be transmitted repeatedly. When the PUSCH repetition type B is used, time resources may be configured by an RRC message and/or DCI. A combination of a reference time resource for PUSCH instances and the number of repetitions may be indicated by DCI (e.g., type 2 CG and/or dynamic grant) or an RRC message (e.g., type 1 CG).

In order to control a transmission power of a sounding reference signal (SRS) resource indicated by an SRS resource indicator (SRI), the base station may estimate a path loss for each SRS resource. The base station may use DCI to control a transmission power for SRS resource(s). The transmission power of the SRS resource(s) may be controlled based on the estimated path loss. The DCI may be scheduling DCI (e.g., DCI format 0_0, DCI format 0_1, DCI format 0_2, DCI format 1_0, DCI format 1_1, or DCI format 1_2) or group common (GC)-DCI (e.g., DCI format 2_2 or DCI format 2_3). The DCI may include a field indicating a transmit power control (TPC) command, and the TPC command may be used to control a transmission power of the terminal. For example, the transmission power of the terminal may increase or decrease based on the TPC command included in the DCI. To determine a transmission power of a PUSCH, the terminal may consider a value obtained based on a path loss, a value according to a TPC command included in DCI, and/or a PUSCH bandwidth indicated by the DCI.

The base station may configure two or more sets in the terminal using higher-layer signaling. The terminal may receive configuration information of the two or more sets from the base station. Elements constituting the two or more sets may be transmission power parameter(s) and may be indicated to be suitable for different scenarios (e.g., URLLC scenario, eMBB scenario). The terminal may receive scheduling DCI or activating DCI allocating a PUSCH resource from the base station, and the scheduling DCI or activating DCI may indicate a set for interpreting transmission power parameter(s). If a different set of transmission power parameter(s) is used, a size of increase or decrease in transmission power indicated by the same TPC command may vary.

When a type 1 configured grant (CG) or type 2 CG is used, a transmission power may be determined based on the DCI format 2_3 for an SRI associated with a PUSCH instance. When the type 2 CG is used, activating DCI may indicate a set of transmission power parameter(s) applicable to a PUSCH occasion. The PUSCH occasion may refer to a PUSCH instance. The terminal may obtain a TPC command for an SRI by receiving GC-DCI, interpret the TPC command to suit the set of transmission power parameter(s) indicated by the base station, and derive a transmission power to be applied to the PUSCH instance based on a result of the interpretation.

In transmission of a dynamically scheduled PUSCH, the terminal may derive a transmission power to be applied to a PUSCH instance based on a combination of GC-DCI and scheduling DCI. By receiving the GC-DCI, the terminal may identify a TPC command corresponding to an SRI and store the identified TPC command. In transmission of a dynamically scheduled PUSCH, a set of transmission power parameter(s) and/or a TPC command applicable to a PUSCH occasion may be indicated by scheduling DCI. The terminal may derive a transmission power to be applied to the PUSCH instance based on a transmission power of an SRI associated with the PUSCH instance.

Repeated HARQ-ACK transmission may be indicated (or configured) by higher-layer signaling for each physical uplink control channel (PUCCH) format. The number of repetitions for a PUCCH format i may be set independently. i may be 1, 3, or 4. The terminal may repeatedly transmit the PUCCH format in slots. In this case, the PUCCH format may be transmitted using the same time resources in the respective slots.

Uplink control information (UCI) types may be classified according to types of information included in UCI. UCI may include at least one of a scheduling request (SR), layer 1-reference signal received power (L1-RSRP), HARQ-ACK, or channel state information (CSI). In exemplary embodiments, ‘UCI’ and ‘UCI type’ may be used with the same meaning. In a repeated transmission operation of UCI, only one UCI type may be transmitted. In order to support this operation, priorities of UCI types may be defined in the technical specifications. One UCI type may be selected, and a PUCCH including the one UCI type may be transmitted repeatedly. In this case, the terminal may assume that other UCI types are not transmitted before transmission of the selected UCI type is completed. In order to support the above-described operation, the base station may indicate the terminal to transmit UCI (e.g., SR or HARQ-ACK) after PUCCH transmission is completed. A waiting time for transmitting the UCI may be long, and the waiting time may act as a scheduling constraint for the base station.

When transmission of HARQ-ACKs in the same slot (or the same subslot) is indicated or when PUCCH time resources indicated by DCIs and/or RRC messages allocating physical downlink shared channels (PDSCHs) overlap with each other, the terminal may generate a HARQ codebook so that the HARQ codebook is transmitted on one PUCCH (e.g., one PUCCH time resource). Within the HARQ codebook, HARQ-ACK bits may be arranged according to an order defined in the technical specifications. Information bits may be generated according to the above-described operation. The terminal may generate coded bits by performing an encoding operation.

A Reed Muller code or polar code may be used in the encoding operation. A code rate applied in the encoding operation may be indicated by higher-layer signaling. For example, one value in a PUCCH format may be a code rate and may be indicated to the terminal.

One codeword may be mapped to one PUCCH. In a repeated PUCCH transmission operation, one UCI type may be generated as a codeword. When a PUCCH is transmitted once, information bits of one UCI type or two or more UCI types may be concatenated, and the terminal may generate one codeword by performing the same encoding operation on the information bits. When a Reed-Muller code or polar code is used, it may be difficult to perform soft combining operations may be difficult in terms of implementation. Therefore, even when a PUCCH is transmitted repeatedly, the same codeword may be transmitted, and the base station may perform a chase combining operation for the same codeword. The codeword or coded bits may refer to a bit string in which a plurality of code blocks are concatenated. A modulation operation may be performed on the codeword, and a result of the modulation operation may be mapped to REs.

Meanwhile, UCIs having the same UCI type may be considered as different information. The UCIs having the same UCI type, which are considered as different information, may be mapped. For example, the UCIs may be generated to support traffic with different priorities. UCI (e.g., SR or HARQ-ACK) supporting eMBB traffic may be considered distinct information from UCI (e.g., SR or HARQ-ACK) supporting URLLC traffic. In this case, information having the same UCI type may be distinguished as different information.

The coded UCI may be mapped to a PUCCH. The same preprocessing scheme (e.g., spatial information, spatial relation) may be maintained in a PUCCH transmission operation. Alternatively, in the PUCCH transmission operation, use of a different preprocessing scheme for each PUCCH may be allowed by RRC signaling of the base station.

In order to support URLLC traffic, it may be preferable for the terminal to perform frequent reception operations in DL resources and/or frequent transmission operations in UL resources. In a time division duplex (TDD) system, the terminal may operate based on a half-duplex scheme. Therefore, a support time of DL traffic and/or UL traffic may increase depending on a slot pattern. On the other hand, in a frequency division duplex (FDD) system, the terminal may simultaneously utilize DL resources and UL resources. Therefore, the problems described above in the TDD system may not occur in the FDD system. The FDD system may use two or more carriers. When two or more serving cells are configured for the terminal in the TDD system, the terminal may utilize DL resources and UL resources.

In a communication system that includes at least one carrier to which FDD is applied (hereinafter referred to as ‘FDD carrier’), there may be no latency problem in the terminal. In a communication system that includes only carrier(s) to which TDD is applied (hereinafter referred to as ‘TDD carrier(s)’), there may be a latency problem in the terminal. To resolve the above-described problem, slots in TDD carriers may be configured according to different patterns.

Carrier aggregation (CA) may be configured in the terminal, and a PCell and SCell(s) may be activated. Depending on whether a common search space (CSS) set is configured in a cell, the cell may be classified into a PCell or an SCell. For example, a CSS set may be configured in the PCell, and a CSS set may not be configured in the SCell. In order to reduce a latency in a communication system supporting URLLC traffic, slots having different patterns may be configured and/or indicated to the terminal.

Transmission of eMBB traffic or URLLC traffic may be supported in a licensed band and/or in an unlicensed band. Carrier(s) belonging to a licensed band or carrier(s) belonging to an unlicensed band may be used alone. Alternatively, depending on a configuration of the base station, all of the carrier(s) belonging to the licensed band and the carrier(s) belonging to the unlicensed band may be utilized through frequency aggregation.

In exemplary embodiments, two or more terminals may receive data from one or more TRPs and transmit data to one or more TRPs. It may be assumed that one base station or one server performs management operations and/or scheduling operations for one or more TRPs among a plurality of TRPs. The TRPs may be directly connected. Alternatively, the TRPs may be connected through the base station. The above-described connection may be a connection according to an Xn interface or a radio interface (e.g., 3GPP NR interface).

A shadow area may exist between areas supported by the TRPs. Therefore, the TRPs may resolve the shadow area through cooperative transmissions. The cooperative transmissions may be performed for a terminal located between the TRPs. Even when a shadow area does not exist, a large number of TRPs (or base stations) may be deployed to transmit and receive a lot of data, and a quality of radio links may be improved by the TRPs.

According to cooperative transmission and cooperative reception of TRPs, communication schemes may be classified into dynamic point selection (DPS) and joint transmission (JT). For a specific physical resource block (PRB) set, DPS may be a method of receiving data through one TRP, and JT may be a method of receiving data through two or more TRPs. Dynamic point blanking (DPB) may be a type of JT. When DPB is used, the terminal may not receive data from some TRPs and may receive data from the remaining TRPs. JT may be further classified into coherent JT and noncoherent JT. Depending on whether coherent combining operations are performed on signals received from TRPs, coherent JT or non-coherent JT may be used.

Depending on a latency and/or traffic allowance of a backhaul to which base stations or TRPs are connected, the TRPs may participate in cooperative transmission and/or cooperative reception in real time. The terminal may support JT by receiving a DCI (e.g., single DCI (sDCI)). Alternatively, the terminal may support JT by receiving multiple DCIs (e.g., multi-DCI (mDCI)).

When sDCI is used, the terminal may transmit and receive data with TRPs. When sDCI is used, it may be preferable that the TRPs cooperate through a backhaul without latency. When mDCI is used, the terminal may transmit and receive data with some TRPs. When the terminal transmits and receives data with other TRPs, it may be difficult for the other TRPs to cooperate in real time through a backhaul. It may be preferable to allocate semi-static resources to the other TRPs.

A CORESET pool index may be used to identify a TRP. A CORESET pool may be a set of CORESETs, and a transmission configuration indication (TCI) state applied to each CORESET may be independently indicated to the terminal through RRC signaling and/or MAC control element (CE) signaling. A CORESET pool index may not necessarily correspond to a TRP. Specifically, a TRP may be classified into a transmission point (TxP) and a reception point (RxP). A CORESET pool index may correspond to an RxP. For example, an Rx beam for a TxP may be derived from a TCI state, and uplink signals/channels scheduled by DCIs detected in CORESETs belonging to a CORESET pool indicated by one CORESET pool index may be interpreted as being received from the same RxP.

In order for a terminal to obtain a gain through coherent combining, there needs to be a certain degree of synchronization between TRPs for the terminal, and CSI reports for the TRPs need to be shared. In case where these are not possible, it may be advantageous in terms of performance to perform noncoherent combining in the terminal.

When a terminal is mounted on a vehicle, restrictions on the size and weight of the terminal may be relaxed. In case of a terminal carried by a person, portability of the terminal may be taken into consideration.

Small cells or integrated access backhaul (IAB) nodes may be deployed to extent signal's reach. A throughput of a small cell or IAB node may be affected by a quality of a backhaul link, and securing the backhaul network may be expensive. As an alternative to this, a wireless relay device may be deployed to deliver higher quality signals to the terminal. The wireless relay devices may be classified into several types depending on a scheme of delivering signals. As a wireless relay device supports more functions, it can show performance similar to that of a base station, and as a wireless relay device supports fewer functions, it can be deployed at a lower cost. The wireless relay device considered in the present disclosure may perform a function of forming beams to terminals and a minimum function of data forwarding. The base station may transmit wireless signals to control these wireless relay devices. Appropriate parameters for the wireless relay device may be configured using these wireless signals.

In the present disclosure, transmission of a channel may refer to transmission of a message, data, signal, and/or information on the channel, and reception of a channel may refer to reception of a message, data, signal, and/or information on the channel. The channel may be a physical downlink control channel (PDCCH), physical downlink shared channel (PDSCH), physical uplink control channel (PUCCH), physical uplink shared channel (PUSCH), physical random access channel (PRACH), physical sidelink broadcast channel (PSBCH), physical sidelink control channel (PSCCH), physical sidelink shared channel (PSSCH), and/or physical sidelink feedback channel (PSFCH).

In a communication system supporting time division duplex (TDD), downlink (DL) communication and uplink (UL) communication may be performed in different time resources. A ratio between a DL time during which DL communication is performed and a UL time during which UL communication is performed may be determined according to a ratio of traffic (e.g., DL traffic and/or UL traffic). For example, in an NR system, since the amount of DL traffic is greater than the amount of UL traffic, DL slots may be allocated more than UL slots. For example, slots (e.g., slot patterns) may be configured to repeat a pattern ‘DDDSU’. D may indicate a DL slot, S may indicate a special slot including DL symbol(s), flexible (FL) symbol(s), and UL symbol(s), and U may indicate a UL slot. An arrangement order of symbols in the S slot may be DL symbol(s)-FL symbol(s)-UL symbol(s). A base station may indicate or configure a slot pattern to terminal(s) through signaling (e.g., RRC signaling). The base station may indicate some FL symbol(s) among FL symbols configured by RRC signaling as DL symbol(s) or UL symbol(s). The some FL symbol(s) may be indicated as DL symbol(s) or UL symbol(s) through DCI.

A terminal located in a boundary region of a cell may perform repeated transmission of UL signal/channel to deliver UL traffic to the base station. In this case, at the base station, signal to interference plus noise ratio (SINR) can be improved, and block error rate (BLER) can be reduced. In the present disclosure, a UL signal/channel may refer to a UL signal and/or UL channel, and a DL signal/channel may refer to a DL signal and/or DL channel. The base station may instruct the terminal to perform repeated transmission of a UL signal/channel, and the terminal may perform repeated transmission of the UL signal/channel based on the instruction from the base station. The base station may instruct the terminal to perform repeated reception of a DL signal/channel, and the terminal perform repeated reception of the DL signal/channel based on the instruction from the base station. When UL slots do not occur frequently, a long delay time may occur for the terminal to obtain sufficient UL slots for repeated transmission. For example, when a pattern ‘DDDSU’ is configured for the terminal and a subcarrier spacing (SCS) is 30 kHz, a UL slot may occur every 2.5 ms. In this case, a time required for four repetitions of the UL signal/channel transmission may be 10 ms.

To reduce the time delay, a method of improving a frequency structure of a slot may be considered. The base station may perform full-duplex communication. A frequency region for DL symbols (or FL symbols) in a DL slot (or in a DL slot and an S slot) may be divided into subbands. The base station may perform a transmission operation of a DL signal/channel or a reception operation of a UL signal/channel in some subbands of the DL slot (e.g., DL symbols or FL symbols). Although the terminal performs half-duplex communication, the terminal may perform a transmission operation of a UL signal/channel in the DL slot (e.g., DL symbols or FL symbols). A symbol that allows both DL communication and UL communication may be referred to as a subband full duplex (SBFD) symbol. For convenience, an SBFD symbol may be referred to as ‘SD symbol’. In other words, in the present disclosure, SD symbols may refer to SBFD symbols. SD may be an abbreviation of SBFD. An SD symbol may be interpreted as an SD resource, and an SBFD symbol may be interpreted as an SBFD resource. The base station may configure SD symbols and/or non-SD symbols to the terminal through signaling. The terminal may receive configuration information of SD symbols and/or non-SD symbols from the base station. The configuration information of SD symbols may be SBFD configuration information. The configuration information of non-SD symbols may be UL-DL configuration information. The non-SD symbols may include UL symbols, DL symbols, and/or FL symbols. UL symbols, DL symbols, and/or FL symbols may be indicated (e.g., configured) based on UL-DL configuration information. DL communication or UL communication may be performed in non-SD symbols. A non-SD symbol may be interpreted as a non-SD resource or ND resource. The SBFD configuration information and the UL-DL configuration information may be included in system information (e.g., SIB1).

Since DL communication and UL communication are performed in one SD symbol (e.g., the same time resource), a guard band may be introduced. A bandwidth of the guard band may vary depending on a level of interference at the base station. When different antenna arrays are used, a coupling between DL communication and UL communication may be reduced. When a small amount of coupling occurs between DL communication and UL communication, the guard band may be unnecessary or a small bandwidth for the guard band may be needed. In this case, the guard band may not be separately allocated. Alternatively, a small number of PRBs may be allocated for the guard band.

When a small amount of coupling occurs between DL communication and UL communication, a separate Rx filtering operation or Rx processing operation may be performed at the base station, but a separate Tx filtering operation or Tx processing operation may be unnecessary at the terminal. The filtering operation may be a radio frequency (RF) filtering operation. When the RF filtering operation is performed, spectral emission (e.g., out-of-band (OOB) emission or adjacent channel leakage ratio (ACLR)) affecting adjacent PRB(s) may be reduced, and saturation of RF components may be prevented.

A DL subband (e.g., DL usable PRB(s)) and a UL subband (e.g., UL usable PRB(s)) may have different frequencies. When a leakage occurs, an analog-to-digital converter (ADC) may become saturated, and small signals may be ignored. The base station may appropriately arrange shielding between antenna arrays or apply a signal processing method. The base station may allocate a guard band having a narrow bandwidth.

A base station may establish an RRC connection with a terminal in order to handle traffic demand of the terminal. A plurality of terminals may select or reselect a base station (e.g., cell) by using a cell search procedure. The base station (e.g., cell) may periodically transmit synchronization signals and/or system information. The system information may be divided into MIB and SIBs, and SIBs may be further divided into SIB1, SIB2, and the like. The terminal may camp on a specific base station (e.g., specific cell) by using MIB and SIB. The synchronization signals and MIB may be combined to generate a synchronization signal block (SSB), and SSB may be transmitted. In other words, SSB may include synchronization signals and MIB. In the present disclosure, SIB may mainly refer to SIB1, but SIB may not be limited to SIB1. In other words, SIB may refer to another SIB including SIB1 or other SIBs other than SIB1.

When downlink (DL) traffic to be transmitted to the terminal occurs in the base station (e.g., network), the base station may transmit a paging message to an unspecified plurality of terminals for detection of the terminal and establishment of an RRC connection with the terminal. The terminal may receive the paging message from the base station, and may establish an RRC connection with the base station by performing a random access procedure based on the paging message.

When uplink (UL) traffic to be transmitted to the base station (e.g., network) occurs in the terminal, the terminal may perform a random access procedure in order to establish an RRC connection with the base station on which the terminal camps. After the RRC connection between the terminal and the base station is established, the base station (e.g., serving cell) may control the terminal, and a data transmission and reception procedure between the base station (e.g., serving cell) and the terminal may be performed.

The base station may not know the operating states of terminals camping on the base station. Therefore, the base station may periodically transmit SSB and/or SIBx. Due to periodic transmission of SSB and/or SIBx, power of the base station may not be saved. The operating state of the terminal may be an RRC connected state, an RRC inactive state, or an RRC idle state. In SIBx, x may be a natural number.

For example, while the base station operates in a normal mode, the base station may transmit SIBx based on a preset periodicity. While the base station operates in a low-power mode, the base station may transmit SIBx based on a periodicity longer than the preset periodicity. In another method, the base station may not transmit SIBx in the low-power mode.

The base station may transmit SIBx based on a request of terminal(s). SSB may be periodically transmitted, and MIB included in SSB may include information explicitly indicating that SIBx is not transmitted or information implicitly indicating that SIBx is not transmitted. Configuration information (e.g., CORESET information or Type0-PDCCH CSS set information) of a control channel for scheduling SIBx may not be included in MIB. When MIB does not include the configuration information of a control channel for scheduling SIBx, it may indicate that SIBx is not transmitted.

MIB may include information indicating that SSB (e.g., SSB including the MIB) is a cell defining (CD)-SSB or a non-cell defining (NCD)-SSB. MIB may include configuration information of CORESET 0 and/or configuration information of search space 0.

One index indicated by MIB may indicate a multiplexing pattern between SSB and CORESET, a bandwidth of a CORESET, a number of symbols of a CORESET, and an RB offset. When SSB and CORESET are not multiplexed, a cell may not be defined, and in this case, SSB may be a NCD-SSB. MIB may include k_{SSB}, and k_{SSB} may be an offset (e.g., subcarrier offset) indicating where a starting subcarrier of SSB is located in an entire RB grid. When k_{SSB} is smaller than a specific value, the terminal may determine SSB associated with k_{SSB} as a CD-SSB, and may search a Type0-PDCCH CSS set for reception of SIBx (e.g., SIB1). When k_{SSB} belongs to a remaining range, the terminal may determine SSB associated with k_{SSB} as a NCD-SSB, and may not search the Type0-PDCCH CSS set. In other words, the terminal may not attempt reception of SIBx (e.g., SIB1). In this case, the terminal may perform a cell reselection procedure again.

In a mode of not transmitting SIB1, the base station may transmit NCD-SSB. In a mode of transmitting SIB1, the base station may transmit CD-SSB.

The terminal may determine presence or absence of a CORESET DM-RS. When a CORESET DM-RS is present, the terminal may assume that SIB1 is transmitted. When a CORESET DM-RS is absent, the terminal may assume that SIB1 is not transmitted. In this case, the terminal may perform a cell reselection procedure again. The CORESET DM-RS may be a DM-RS (e.g., DM-RS for DCI) transmitted in the CORESET.

A part of SIB1 may be defined as SIB1A, and a remaining part of SIB1 may be defined as SIB1B. A transmission periodicity of SIB1A may differ from that of SIB1B. In another method, SIB1A may be periodically transmitted, and SIB1B may not be periodically transmitted. SIB1A may include at least RACH configuration information (e.g., configuration information of PRACH transmission resources).

A value of k_{SSB} may be utilized as a counter, and when the counter expires, k_{SSB} having a range indicating NCD-SSB may be changed to a range indicating CD-SSB. The terminal may predict a time at which the base station transmits SIBx by using a value of the counter.

In the above exemplary embodiments, the base station may or may not transmit SIBx as needed. It may be preferable to determine whether a condition for switching the mode of not transmitting SIBx to the mode of transmitting SIBx is satisfied. The terminal may transmit a UL discovery signal (DRS) or a PRACH to the base station in order to request switching to the mode of transmitting SIBx.

The terminal may transmit a UL DRS after completing establishment of the RRC connection with the base station. The terminal may use a PRACH for transmission of the UL DRS. The base station may indicate, to the terminal, resources and/or configuration information for UL DRS. Configuration information of RACH occasions (ROs) or configuration information of UL DRS occasions (DOs) may need to be signaled to the terminal in order to transmit a PRACH. Methods of transmitting a UL DRS by using a PRACH (e.g., a PRACH preamble or a preamble) will be described below.

Frequency bands used in a communication system may be classified into FR1, FR2, FR3, and the like. The frequency bands may be classified based on center frequencies. FR1, FR2, FR3,and the like may be used to refer to International Mobile Telecommunications (IMT) frequency bands. FR1 may be a frequency band below approximately 7 GHz and may be mainly used in 1G, 2G, 3G, and 4G communication systems. FR2 may be subdivided into FR2-1 and FR2-2. FR2-1 may be a millimeter wave (mmW) region including 30 GHz (e.g., 24.25 GHz to 52.6 GHz). FR2 -2 may be a mmW region including 60 GHz (e.g., 52.6 GHz to 71 GHz).

FR3 may be a frequency band between 7.125 GHz and 24.25 GHz. For example, FR3 may represent a frequency band preceding a start frequency of FR2-1. In another meaning, FR3 may be a part of FR1. In this case, FR1 -1 may mean a low band below approximately 7 GHz. FR 1-2 may represent a frequency band between approximately a 7 GHz boundary and 15 GHz.

A 6G communication system may operate in a frequency band lower than the above-described frequency bands. In the mmW region, directivity may be disadvantageous in securing coverage, so a low-frequency band having good diffraction characteristics may be necessary. An FR3 band may be difficult to allocate as IMT spectrum because it is wide. Since other wireless services already operate in the FR3 band, methods of avoiding interference with other wireless services may be needed.

The terminal may search a serving base station in a specific frequency band, may establish an RRC connection with the searched serving base station, and may operate in an RRC connected state with the serving base station. The serving base station may transmit and/or receive signals and/or channels by using two or more serving cells based on an amount of traffic, a location of the terminal, and like. The above operation may refer to a carrier aggregation operation. When the carrier aggregation operation is performed, one serving cell may be a primary cell (PCell), and remaining serving cells may be second cells (SCells). Each serving cell may be defined in each carrier.

Each of the PCell and the SCells may perform a different role in each carrier. For example, system information may be transmitted and received in the PCell. The PCell may be utilized as a serving cell for PUCCH transmission.

An activated SCell and the PCell in the CA environment may belong to different carriers and may have different bandwidth parts (BWPs). In an unlicensed band, the base station and/or the terminal may perform listen-before-talk (LBT) operations. In an unlicensed band, a bandwidth of an LBT subband may be narrower than a bandwidth of a carrier or a BWP. A carrier or a BWP may include one or more LBT subbands.

Frequencies available in FR3 may be difficult to allocate as a wide band. Therefore, methods of aggregating fragmented frequencies and using the aggregated frequencies as one band may be applied.

### Framework

### TCI state

Methods of managing beams may differ for DL signals/channels and UL signals/channels. A terminal may receive an indication of an Rx beam for a CORESET through RRC signaling or MAC CE to receive a PDCCH. The terminal may receive an indication of an Rx beam for a PDSCH from scheduling DCI to receive a PDSCH. The terminal may receive an indication of an Rx beam through RRC signaling to receive a CSI-RS. The terminal may receive an indication of a Tx beam from scheduling DCI to transmit a PUSCH. The Tx beam may be derived from a sounding reference signal (SRS) resource, SSB, or CSI-RS. The terminal may receive an indication of a Tx beam through RRC signaling to transmit a configured grant (CG) PUSCH. The terminal may receive an indication of a Tx beam through RRC signaling, an SSB, or a CSI-RS to transmit an SRS.

The Rx beam may refer to a beam that the terminal applies in implementation. When a TCI state is indicated to the terminal, the Rx beam may be derived from an RS that provides qcl-type2 (or qcl-typeD) to the terminal for the TCI state.

When an Rx beam applied to a DL signal/channel and/or a Tx beam applied to a UL signal/channel is not indicated to the terminal, the terminal may assume that a default beam is used. The above exemplary embodiments may mean that an Rx beam or a Tx beam may be associated with a specific DL channel or a specific UL channel, respectively.

For example, when an Rx beam for a PDSCH is not indicated or an indicated Rx beam is not applicable to a PDSCH, the terminal may apply an Rx beam for reception of a CORESET having the lowest index (e.g., lowest identifier). Alternatively, the terminal may apply an Rx beam of a CORESET in which scheduling DCI is received.

For example, when a Tx beam for a PUSCH is not indicated or an indicated Tx beam is not applicable to a PUSCH, the terminal may derive a Tx beam from an Rx beam for reception of a CORESET based on beam reciprocity. Alternatively, the terminal may derive a Tx beam from an Rx beam of a CORESET in which scheduling DCI is received based on beam reciprocity. In such a case, the terminal may derive the Tx beam, and may use a separate RS in order to determine a Tx power for the Tx beam.

The communication node (e.g., the base station or the terminal) may manage the same Tx beam and Rx beam in DL signals/channels and UL signals/channels. A TCI state may be introduced in order to indicate to the terminal an Rx beam for a PDSCH. The Rx beam may also be utilized in other DL signals/channels and UL signals/channels. According to the above exemplary embodiment, a protocol overhead for beam indication by the base station may be reduced. As a method using a DCI format, the base station may scramble a DCI format 1_1 (e.g., a cyclic redundancy check (CRC) of the DCI format 1_1) by using a cell (C)-radio network temporary identifier (RNTI) or a configured scheduling (CS)-RNTI, and may indicate a TCI state to the terminal by combining one or more information fields included in the DCI format 1_1. The DCI format 1_1 scrambled by the C-RNTI may schedule a downlink-shared channel (DL-SCH). The DCI format 1_1 scrambled by the CS-RNTI may not schedule a DL-SCH. The DCI format 1_1 may refer to a non-fallback DCI format. The above exemplary embodiments may not be limited to the DCI format 1_1, and may be applied to operations based on a DCI format 1_2, a DCI format 1_3, or another DL scheduling DCI format.

When a TCI state is indicated to the terminal as a single index, the terminal may determine, based on information indicated by RRC signaling, whether the index indicates an Rx beam for a DL signal/channel or a Tx beam for a UL signal/channel. For example, the one TCI state may be applied to a PDSCH, PDCCH (e.g., CORESET), PUSCH, and/or PUCCH (e.g., dedicated PUCCH). The one TCI state may also be applied to a CSI-RS and an SRS according to configuration.

The above exemplary embodiments may be extended to single TRP (sTRP)-based operations and/or multiple TRP (mTRP)-based operations. For a terminal to which mTRP configuration is indicated, it may be preferable that two or more TCI states are indicated. The reason is that a TCI state includes qcl-type1 and qcl-type2 for sTRP and does not include information for mTRP. Two or more TCI states may be regarded as a TCI state group, and a number of TCI states equal to a number of TRPs may be derived based on an index of a TCI state group. When one index for TCI state(s) is indicated to the terminal, interpretation of the one index for sTRP may differ from interpretation of the one index for mTRP.

DL coherent joint transmission (CJT) may be activated by two or more TRPs, and a scheduling DCI format may include an information field indicating information for TRPs. The above exemplary embodiments may be applied to single DCI (sDCI)-based mTRP.

When TRP1 and TRP2 support DL CJT, a PDSCH may be indicated to the terminal to be received from at least one of TRP1 and TRP2. The TRPs may provide DL synchronization (e.g., time synchronization and/or frequency synchronization) to the terminal by using SSB and/or CSI-RS for tracking. The terminal may receive the PDSCH based on a TCI state field, a TRP selection field (e.g., TCI selection field), or a combination of the TCI state field and the TRP selection field. In the present disclosure, the TCI selection field and the TRP selection field may be interpreted as the same field or may be interpreted as mutually distinguished fields. The TCI selection field and/or the TRP selection field may be a field (e.g., TRP indication field or TRP indication information) used to indicate the TRP. In the present disclosure, the terms ‘TCI’, ‘TRP’, and ‘beam’ may have meanings corresponding to one another. For example, a TCI (e.g., TCI state) indicated by the TCI selection field may be interpreted as corresponding to a TRP and/or a beam. A TRP indicated by the TRP selection field may be interpreted as corresponding to a TCI (e.g., TCI state) and/or a beam.

For example, the terminal may derive two TCI states from the TCI state field. A size of the TRP selection field may be 2 bits. Each bit of the TRP selection field may indicate whether a certain TCI (i.e., TRP) performs DL transmission (e.g., PDSCH transmission). TCI states may be indicated as x and y. x may indicate a certain combination of qcl-type1 and qcl-type2. y may indicate another combination of qcl-type1 and qcl-type2.

When the TCI selection field is set to ‘10’, the terminal may regard a TCI state as x and may derive qcl-type1 and qcl-type2. Such a configuration may mean that a DL signal/channel (e.g., PDSCH) is received from TRP1. When the TCI selection field is set to ‘01’, the terminal may regard a TCI state as y and may derive qcl-type1 and qcl-type2. Such a configuration may mean that a DL signal/channel (e.g., PDSCH) is received from TRP2.

When the TCI selection field is set to ‘11’, the terminal may determine that both TCI states x and y are applied to reception of a PDSCH. Such a configuration may mean that TRP1 and TRP2 perform DL transmission (e.g., PDSCH transmission) based on CJT.

### UE-Initiated Reporting

A serving cell (e.g., base station) may indicate periodic CSI reporting or aperiodic CSI reporting to a terminal. The periodic CSI reporting may be regarded as including semi-persistent CSI reporting. In the present disclosure, the term ‘serving cell’ may refer to a base station, a serving base station, or a serving cell base station.

The terminal may perform beam measurement and may determine L1-RSRP (or L1-SINR). The terminal may perform beam measurement for two or more RSs, and may report a group-based CSI report including two or more L1-RSRPs and/or two or more beam identifiers. The group-based CSI report may be regarded as UCI, and may be transmitted to the serving cell through a PUCCH (or PUSCH).

The serving cell may indicate an event, a condition, a preconfigured time window, an RS resource set, and/or a maximum value of a counter to the terminal through signaling (e.g., RRC signaling). The terminal may identify the event, the condition, the preconfigured time window, the RS resource set, and/or the maximum value of the counter through signaling of the base station. The terminal may measure beams by using RSs, and may determine whether the measurement result of the beams satisfies a certain condition. When the measurement result of the beams satisfies a certain condition (e.g., condition indicated by the base station), the terminal may increase a value of a counter. When the value of the counter is equal to or greater than a specific value (e.g., maximum value) before the preconfigured time window ends, the terminal may regard that an event occurs. In other words, when the value of the counter reaches the specific value (e.g., maximum value) before the preconfigured time window ends, the terminal may regard that an event occurs.

When an event occurs, the terminal may report the measurement result (e.g., L1-RSRPs) of the RSs to the serving cell. In other words, the terminal may transmit a CSI report to the serving cell. The serving cell may receive the measurement result (e.g., L1-RSRPs) of the RSs from the terminal. The CSI report described above may have characteristics different from a periodic CSI report and an aperiodic CSI report. The terminal may determine whether or not to perform the CSI reporting based on a determination result of the terminal.

### Discontinuous Transmission (DTX) and Discontinuous Reception (DRX)

A serving cell may perform DTX and/or DRX in order to reduce power consumption. DTX performed in the serving cell may be referred to as cell DTX. DRX performed in the serving cell may be referred to as cell DRX. A cell DTX pattern may be activated or deactivated. Activation of the cell DTX pattern may indicate activation of cell DTX or a cell DTX operation. Deactivation of the cell DTX pattern may indicate deactivation of cell DTX or a cell DTX operation. A cell DRX pattern may be activated or deactivated. Activation of the cell DRX pattern may indicate activation of cell DRX or a cell DRX operation. Deactivation of the cell DRX pattern may indicate deactivation of cell DRX or a cell DRX operation.

In an on-duration of an activated cell DTX pattern, the serving cell may perform transmission. In other words, in an on-duration of the activated state of the cell DTX pattern, the serving cell may perform transmission without performing cell DTX operation. All durations of a deactivated cell DTX pattern may be regarded as on-durations, and in all durations of the deactivated cell DTX pattern, the serving cell may perform transmission. In other words, the deactivated cell DTX pattern may not be divided into an on-duration and an off-duration, and the serving cell may perform transmission in all durations of the deactivated cell DTX pattern. In an on-duration of an activated cell DRX pattern, the serving cell may perform reception. All durations of a deactivated cell DRX pattern may be regarded as on-durations, and the serving cell may perform reception in all durations of the deactivated cell DRX pattern. In other words, the deactivated cell DRX pattern may not be divided into an on-duration and an off-duration, and the serving cell may perform reception in all durations of the deactivated cell DRX pattern. In an off-duration of the activated cell DTX pattern, a specific signal/channel (e.g., L1 signal/channel) may not be transmitted by the serving cell. In an off-duration of the activated cell DRX pattern, a specific signal/channel (e.g., L1 signal/channel) may not be received by the serving cell.

The deactivated state of the cell DTX pattern may indicate a state in which a cell DTX operation is not performed, and in the activated state of the cell DTX pattern, the serving cell may perform discontinuous transmission. The activated state of the cell DTX pattern may indicate a state in which a cell DTX operation is performed, and in the on-duration and off-duration of the activated cell DTX pattern, the serving cell may perform the cell DTX operation. The deactivated state of the cell DRX pattern may indicate a state in which a cell DRX operation is not performed, and in the activated state of the cell DRX pattern, the serving cell may perform discontinuous reception. The activated state of the cell DRX pattern may indicate a state in which a cell DRX operation is performed, and in the on-duration and off-duration of the activated cell DRX pattern, the serving cell may perform the cell DRX operation.

When an RRC connection between the terminal and the serving cell is established, the terminal may receive an indication of a periodic cell DTX pattern and/or a periodic cell DRX pattern from the serving cell. The cell DTX pattern and the cell DRX pattern may be configured independently. Alternatively, the cell DTX pattern and the cell DRX pattern may be configured simultaneously.

Up to two cell DTX patterns and up to two cell DRX patterns may be configured by one MAC entity. The one MAC entity may be defined in multiple serving cells. Cell DTX may be configured only when connected (C)-DRX is indicated to the terminal.

The cell DTX pattern and the cell DRX pattern may be activated or deactivated by RRC signaling. In another method, the cell DTX pattern and the cell DRX pattern may be dynamically activated or deactivated by using DCI (e.g., L1 group-common DCI, DCI format 2_9).

The serving cell (e.g., base station) may support two or more TRPs, one terminal may be connected to the two or more TRPs, and communication for the terminal may be supported by the two or more TRPs. One TRP may operate as a transmission point (TxP) or a reception point (RxP). A TxP operation may be interpreted as a DTX operation of a TRP (or application of a DTX pattern to the TRP). An RxP operation may be interpreted as a DRX operation of a TRP (or allocation of a DRX pattern to the TRP). The serving cell may perform TRP DTX (e.g., TRP-level DTX pattern) and TRP DRX (e.g., TRP-level DRX pattern) for interference management and/or minimization of power consumption. The serving cell may apply the TRP DTX pattern or TRP DRX pattern based on a traffic pattern. When DL traffic is small, the serving cell may apply the TRP DTX pattern. When UL traffic is small, the serving cell may apply the TRP DRX pattern. The TRP DTX pattern may refer to a beam DTX pattern (e.g., beam-level DTX pattern). TRP DRX may refer to a beam DRX pattern (e.g., beam-level DRX pattern).

The base station may be associated (e.g., connected) with one or more TRPs. Each of the one or more TRPs may apply a TRP DTX pattern and/or a TRP DRX pattern. The base station may transmit at least one of TRP DTX configuration information (e.g., TRP DTX pattern configuration information) or TRP DRX configuration information (e.g., TRP DRX pattern configuration information) to the terminal through signaling (e.g., RRC signaling). The terminal may receive at least one of the TRP DTX pattern configuration information or the TRP DRX pattern configuration information through signaling of the base station. The TRP DTX pattern configuration information and the TRP DRX pattern configuration information may be configured for each TRP associated with the base station. In another method, the TRP DTX pattern configuration information and the TRP DRX pattern configuration information may be configured for all TRPs associated with the base station.

The TRP DTX pattern configuration information and the TRP DRX pattern configuration information may each include at least one of an on-duration timer, cycle start information, a cycle offset, or a slot offset. The TRP DTX pattern configuration information may further include information indicating activation or deactivation of a TRP DTX pattern and/or information indicating a TRP in which the TRP DTX pattern is activated or deactivated. The TRP DRX pattern configuration information may further include information indicating activation or deactivation of a TRP DRX pattern and/or information indicating a TRP in which the TRP DRX pattern is activated or deactivated.

When a TRP DTX pattern is activated, a TRP may perform transmission based on a DTX operation. For example, the TRP may perform DL transmission in an on-duration, and may not perform DL transmission in an off-duration. When a TRP DTX pattern is deactivated, the TRP may perform transmission without performing a DTX operation. In other words, when a TRP DTX pattern is deactivated, the TRP may perform DL transmission regardless of the TRP DTX pattern configuration information.

When a TRP DRX pattern is activated, the TRP may perform reception based on a DRX operation. For example, the TRP may receive UL transmission in an on-duration, and may not receive UL transmission in an off-duration. When a TRP DRX pattern is deactivated, the TRP may perform reception without performing a DRX operation. In other words, when a TRP DRX pattern is deactivated, the TRP may receive UL transmission regardless of the TRP DRX pattern configuration information.

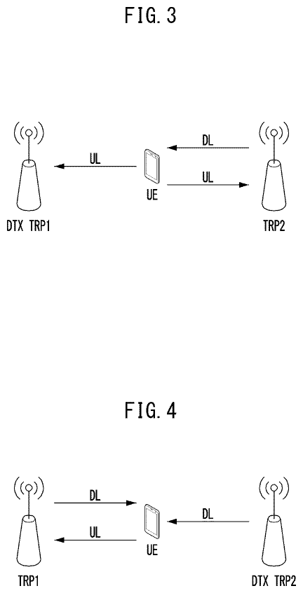

FIG. 3 is a conceptual diagram illustrating RxP operation of TRP1 supporting a DTX pattern.

Referring to FIG. 3, in a scenario in which the serving cell operates TRP1 and TRP2, TRP1 (e.g., DTX TRP1) supporting a DTX pattern may operate as an RxP. In this case, the terminal may receive a DL signal/channel from TRP2 instead of TRP1, and may transmit a UL signal/channel to TRP1 and TRP2. A TRP1 DTX pattern may refer to a DTX pattern applied in TRP1.

FIG. 4 is a conceptual diagram illustrating TxP operation of TRP2 supporting a DRX pattern.

Referring to FIG. 4, in a scenario in which the serving cell operates TRP1 and TRP2, TRP2 (e.g., DRX TRP2) supporting a DRX pattern may operate as a TxP. In this case, the terminal may transmit a UL signal/channel to TRP1 instead of TRP2, and may receive a DL signal/channel from TRP1 and TRP2. A TRP2 DRX pattern may refer to a DRX pattern applied in TRP2.

When an RRC connection between the terminal and the serving cell is established, the terminal may receive an indication of a periodic TRP DTX pattern and/or a periodic TRP DRX pattern from the serving cell. The TRP DTX pattern and the TRP DRX pattern may be configured independently. Alternatively, the TRP DTX pattern and the TRP DRX pattern may be configured simultaneously. Up to N cell DTX patterns and up to N cell DRX patterns may be configured by one MAC entity. The one MAC entity may be defined in multiple serving cells. TRP DTX may be configured only when C-DRX is indicated to the terminal. N may be a natural number. For example, N may be 2. For each TRP, N TRP DTX patterns and/or N TRP DRX patterns may be indicated (e.g., configured) to the terminal.

The TRP DTX pattern and the TRP DRX pattern may be activated or deactivated by RRC signaling. The TRP DTX pattern and the TRP DRX pattern may also be dynamically activated or deactivated by using a DCI format (e.g., L1 group-common DCI format). In the present disclosure, the DCI format for activation or deactivation of the TRP DTX pattern and the TRP DRX pattern may be referred to as a DCI format 2_A. The DCI format 2_A may be generated by reusing a group-common DCI format supported in the technical specifications. Alternatively, the DCI format 2_A may be a newly defined group-common DCI format. When the DCI format 2_A is a newly defined group-common DCI format, the base station may indicate to the terminal a scrambling identifier (e.g., RNTI) for the DCI format 2_A through signaling (e.g., RRC signaling), and the terminal may utilize the scrambling identifier indicated by the base station in order to receive the DCI format 2_A. After an application time (e.g., a preset time) elapses from a reception time of the DCI format 2_A, activation or deactivation for each of the TRP DTX pattern and the TRP DRX pattern indicated by the DCI format 2_A may be applied. The DCI format 2_A may include information indicating one or more TRPs to which activation or deactivation of the TRP DTX pattern is applied and/or information indicating one or more TRPs to which activation or deactivation of the TRP DRX pattern is applied. A may be a natural number. The DCI format for activation or deactivation of each of the TRP DTX pattern and the TRP DRX pattern may be referred to by another term instead of the DCI format 2_A.

The TRP DTX pattern and the TRP DRX pattern may also be dynamically activated or deactivated by using a MAC CE. The MAC CE may be generated by reusing a MAC CE format supported in the technical specifications. Alternatively, the MAC CE may have a newly defined MAC CE format. After a preset time (e.g., application time) elapses from a transmission time of HARQ-ACK for a PDSCH including the MAC CE, information (e.g., activation or deactivation) indicated by the MAC CE may be reflected as new information for the TRP DTX pattern or the TRP DRX pattern. In another method, after the application time (e.g., preset time) from the reception time of the MAC CE, activation or deactivation for each of the TRP DTX pattern and the TRP DRX pattern indicated by the MAC CE may be applied. The MAC CE may include information indicating one or more TRPs to which activation or deactivation of the TRP DTX pattern is applied and/or information indicating one or more TRPs to which activation or deactivation of the TRP DRX pattern is applied.

### Beam Indication DCI

The DCI format 2_A may have a structure similar to a general group-common DCI. Derivation of information corresponding to a certain length from a certain position in the DCI format 2_A may be indicated to terminals. The indication described above may be signaled by the base station to the terminal, and the terminal may operate based on the indication described above. The DCI format 2_A may be mapped in a common search space (CSS) set.

The serving cell may indicate an sDCI-based mTRP operation or a multiple-DCI (mDCI)-based mTRP operation to the terminal through signaling. The terminal may perform the sDCI-based mTRP operation or the mDCI-based mTRP operation indicated by signaling of the base station. In the present disclosure, TRP1 and TRP2 may be controlled by the serving cell, TRP1 may be a macro TRP (e.g., macro cell TRP), and TRP2 may be a small TRP (e.g., small cell TRP). The TRP DTX pattern and/or the TRP DRX pattern may be applied in TRP2 (or small cell TRP).

In sDCI-based mTRP communication, the terminal may receive configuration of a CSS set and a CORESET for the macro TRP and/or configuration of a CSS set and a CORESET for the small TRP. Without distinction between the macro TRP and the small TRP, one CSS set and one CORESET may be indicated to the terminal. The terminal may detect (e.g., receive) the DCI format 2_A in the CSS set (e.g., CSS set in the CORESET).

In mDCI-based mTRP communication, the terminal may receive configuration of a CSS set and a CORESET for the macro TRP and/or configuration of a CSS set and a CORESET for the small TRP. The CORESET of the macro TRP and the CORESET of the small TRP may be distinguished by a CORESET pool index or another identifier. The DCI format 2_A may be detected in a CORESET associated with a CORESET pool index among a plurality of CORESET pool indexes and a CSS set of the CORESET. Alternatively, the terminal may detect the DCI format 2_A in CORESETs associated with all CORESET pool indexes and CSS sets of the CORESETs.

The DCI format 2_A may include information indicating an activated state of the TRP DTX pattern or a deactivated state of the TRP DTX pattern. In the activated state of the TRP DTX pattern, TRP2 may operate in a Tx on-state or a Tx off-state based on configuration of the TRP DTX pattern. In the deactivated state of the TRP DTX pattern, TRP2 may operate in a Tx on-state. The DCI format 2_A may include information indicating an activated state of the TRP DRX pattern or a deactivated state of the TRP DRX pattern. In the activated state of the TRP DRX pattern, TRP2 may operate in an Rx on-state or an Rx off-state based on configuration of the TRP DRX pattern. In the deactivated state of the TRP DRX pattern, TRP2 may operate in an Rx on-state.

In order to indicate the activated/deactivated state of the TRP DTX pattern or the activated/deactivated state of the TRP DRX pattern, a MAC CE may be used. In this case, after a preset time (e.g., application time) elapses from a transmission time of a HARQ-ACK for a PDSCH including the MAC CE, the state of the TRP DTX pattern or the state of the TRP DRX pattern, which is indicated by the MAC CE, may be reflected as a subsequent operation of the terminal.

### DCI Prioritization and Application Delay

The terminal may receive two or more DCI formats, may determine that one DCI format among the two or more DCI formats has a priority, and may operate based on the DCI format having the priority. In another method, the terminal may receive two or more DCI formats, may interpret a combination of the two or more DCI formats, and may operate based on the interpretation. A DCI format 1_1 may include information indicating a beam (e.g., TCI or TRP), and the terminal may identify the beam indicated by the DCI format 1_1. The serving cell may control each beam by transmitting the DCI format 1_1 to each terminal. The DCI format 2_A may be a group-common DCI format, and may be commonly received by a plurality of terminals. The DCI format 2_A may include information (e.g., beam information, TCI information, TRP information) for each of the plurality of terminals, and the information for each of the plurality of terminals may exist at a different position in the DCI format 2_A. The terminal may obtain information for the terminal at a specific position in the DCI format 2_A. In the present disclosure, the DCI format 1_1 may be interpreted as a DL scheduling DCI format (e.g., DCI format that schedules DL transmission). In other words, an operation based on the DCI format 1_1 may be interpreted as an operation based on a DL scheduling DCI format.

When a DL scheduling DCI format (e.g., DCI format 1_1) and the DCI format 2_A are received, the terminal may interpret a beam (e.g., TCI or TRP) based on a combination of the DCI format 1_1 and the DCI format 2_A. After a preset time (e.g., application time) elapses from a reception time of the DCI format 2_A, the terminal may recognize (e.g., apply) the TRP DTX pattern (e.g., state of the TRP DTX pattern) or the TRP DRX pattern (e.g., state of the TRP DRX pattern) indicated by the DCI format 2_A. The terminal may assume that beam indication information and/or scheduling information included in the DCI format 1_1 is applied, and may utilize TRP state information (e.g., state information of the TRP DTX pattern and/or the TRP DRX pattern) derived from the DCI format 2_A based on the assumption. For example, when the DCI format 2_A indicates deactivation of the TRP DTX pattern, the terminal may receive DL transmission scheduled by the DCI format 1_1 via TRP(s) excluding a TRP to which the deactivation of the TRP DTX pattern is applied. In another example, when the DCI format 2_A indicates activation of the TRP DTX pattern, the terminal may receive DL transmission scheduled by the DCI format 1_1 via one or more TRPs (e.g., all TRPs) associated with the serving cell (e.g., base station).

Before a preset time elapses from a reception time of the DCI format 2_A, the terminal may determine TRP state information by using information derived from a previous DCI format 2_A of a previous cycle. In other words, when DL transmission scheduled by the DCI format 1_1 is performed before the application time of the DCI format 2_A elapses, the terminal may determine TRP(s) for reception of a DL signal/channel based on a DCI format 2_A received before the DCI format 2_A and the DCI format 1_1. Beam indication information and/or scheduling information included in the DCI format 1_1 may be interpreted based on TRP state information determined based on the previous DCI format 2_A. The DCI format 2_A may not be most recently received information.

In another method, when a DL scheduling DCI format (e.g., DCI format 1_1) and the DCI format 2_A are received, the terminal may select one DCI format among the DCI format 1_1 and the DCI format 2_A, and may apply the selected DCI format. When the DCI format 1_1 is selected, the DCI format 2_A may not be reflected. In this case, the terminal may determine that information derivable from the DCI format 2_A is less than information derivable from the DCI format 1_1 because sufficient information is derived from the DCI format 1_1.

In another method, the DL scheduling DCI format (e.g., DCI format 1_1) may include a new information field, and the new information field may be used to indicate information that may be included in the DCI format 2_A. In other words, the new information field may indicate activation or deactivation of each of the TRP DTX pattern and the TRP DRX pattern. In such a case, even when the terminal receives only the DCI format 1_1, the terminal may identify a TRP state (e.g., a state of the TRP DTX pattern and/or the TRP DRX pattern). The terminal may regard that information derived from the DCI format 2_A and information derived from the DCI format 1_1 are identical. Alternatively, even when different information is derived from the DCI format 2_A and the DCI format 1_1, the terminal may operate based on the information derived from the DCI format 1_1.

### Beam Indication Mode Switching

In a context of unified TCI state indication (e.g., uTCI state), a beam indication method may be classified into a joint TCI state indication method (e.g., jTCI state indication method) and a separate TCI state indication method (e.g., sTCI state indication method). When the joint TCI state indication method (e.g., joint TCI state indication scheme) is configured for the terminal, the terminal may determine that UL-DL reciprocity is established, and a Tx beam and an Rx beam may have a one-to-one correspondence relationship in a given link. Even when the serving cell indicates one index (e.g., one index for TCI states) to the terminal, the terminal may derive a TCI state of a Tx beam and a TCI state of an Rx beam by using the one index.

When the separate TCI state indication method (e.g., separate TCI state indication scheme) is configured for the terminal, the terminal may apply a Tx beam and an Rx beam differently. The separate TCI state indication method may be configured for the terminal regardless of whether UL-DL reciprocity is established or UL-DL reciprocity is not established.

In a communication system supporting a high-frequency band (e.g., FR2), the terminal may maintain power density (e.g., transmission power) lower than a maximum permissible exposure (MPE) criterion to satisfy frequency regulations. When the power density of the terminal is on a boundary of the MPE, the terminal may not use a Tx beam even when UL-DL reciprocity is established. In such a case, the serving cell may not configure the terminal to derive both a Tx beam and an Rx beam from one index, and the serving cell may indicate a Tx beam and an Rx beam individually to the terminal. In other words, the serving cell may not indicate the joint TCI state indication method to the terminal and may indicate the separate TCI state indication method to the terminal.

The DCI format 2_A indicating a state of the TRP DTX pattern and/or the TRP DRX pattern may indicate switching between the joint TCI state indication method and the separate TCI state indication method. In other words, the DCI format 2_A may further include information indicating switching of the TCI state indication method.

In the activated state of the TRP DTX pattern, transmission of the small TRP may be interpreted as an operation in an on-duration. This may be interpreted as an mTRP scenario in which the terminal may utilize both the macro TRP and the small TRP. The mTRP scenario may be the sDCI-based mTRP scenario or the mDCI-based mTRP scenario. The joint TCI state indication method or the separate TCI state indication method may be configured for the terminal.

When the terminal receives the DCI format 2_A and application of the joint TCI state indication method for the terminal is configured through RRC signaling, the terminal may apply the separate TCI state indication method (e.g., the method indicated by the DCI format 2_A) thereafter. When the terminal receives the DCI format 2_A and application of the separate TCI state indication method for the terminal is configured through RRC signaling, the terminal may apply the joint TCI state indication method (e.g., the method indicated by the DCI format 2_A) thereafter.

The TCI state indication method may be dynamically switched. The base station may transmit, through signaling, information indicating that dynamic switching of the TCI state indication method is enabled to the terminal. The terminal may identify that the dynamic switching of the TCI state indication method is enabled based on signaling of the base station. When the dynamic switching of the TCI state indication method is enabled, the joint TCI state indication method may be dynamically switched to the separate TCI state indication method, and the separate TCI state indication method may be dynamically switched to the joint TCI state indication method. The terminal may identify the TCI state indication method by receiving the DCI format 2_A. The DCI format 2_A may include an information field indicating the TCI state indication method. When the dynamic switching of the TCI state indication method is enabled, the terminal may switch a current TCI state indication method to a TCI state indication method indicated by the DCI format 2_A.

The terminal may expect to receive the DCI format 2_A periodically. The terminal may derive a TCI state indication method by applying the most recently received DCI format 2_A.

The terminal may not always detect the DCI format 2_A. An RRC signaling indicating that the terminal applies one of the joint TCI state indication method or the separate TCI state indication method when the terminal does not receive the DCI format 2_A may be transmitted to the terminal. The terminal may apply the joint TCI state indication method or the separate TCI state indication method basically based on the RRC signaling. In other words, when the RRC signaling indicates a default TCI state indication method (e.g., joint TCI state indication method or separate TCI state indication method) and the DCI format 2_A is not received, the terminal may apply the default TCI state indication method indicated by the RRC signaling.

In another method, a TCI state indication method may be derived in consideration of whether a timer is started or expires. The timer may be started in the terminal after the DCI format 2_A or scheduling DCI is received. The timer may expire after a predetermined time. An expiration time of the timer may be indicated to be equal to or longer than a reception periodicity of the DCI format 2_A. When the DCI format 2_A is periodically received, the terminal may not start the timer. When the DCI format 2_A or scheduling DCI is received after the timer is started, the terminal may restart the timer.

Thereafter, the terminal may regard that the default TCI state indication method is applied. The default TCI state indication may be the joint TCI state indication or the separate TCI state indication. Alternatively, the default TCI state indication may indicate a default beam assumption described later.

In another method, the terminal may not assume either the joint TCI state indication method or the separate TCI state indication method. The terminal may derive a TCI of a DL signal/channel and/or a UL signal/channel based on a default beam assumption. The terminal may determine a TCI state for a PDSCH by referring to a TCI field derived from scheduling DCI, and the terminal may derive a TCI state for other DL signals/channels and/or other UL signals/channels based on another assumption.

For example, the terminal may assume that a CORESET has a TCI state indicated through RRC signaling. The terminal may derive a TCI state for a PUCCH based on an Rx beam applied to a CORESET in which scheduling DCI is detected.

A case in which dynamic scheduling is indicated to the terminal may be considered. The terminal may receive a PDCCH and a PDSCH from the serving cell and may transmit a PUCCH to the serving cell. Alternatively, the terminal may receive a PDCCH from the serving cell and may transmit a PUSCH to the serving cell. The terminal may need to reflect a state of the TRP DTX pattern or a state of the TRP DRX pattern before processing the above-described reception operation and/or transmission operation. The TRP state may be changed at a time t (e.g., slot t). A TCI state for a signal/channel may be a TCI state x before a boundary (e.g., time t), and the TCI state for the signal/channel may be a TCI state y after the boundary (e.g., time t). At the boundary, the TCI state may be changed from the TCI state x to the TCI state y. According to the technical specifications, scheduling DCI may indicate a TCI state for a DL signal/channel and/or a UL signal/channel to the terminal. When the scheduling DCI does not include a TCI state for a DL signal/channel and/or a UL signal/channel, the terminal may derive a TCI state based on the default beam assumption.

Among signals/channels indicated by scheduling DCI, some signals/channels may follow a TCI state indicated by the scheduling DCI or the default beam assumption, and remaining signals/channels may follow a TCI state derived from separate DCI. The separate DCI may be the DCI format 2_A. In another method, based on a TCI state indication method derived from the separate DCI, the TCI state indicated by the scheduling DCI may be reinterpreted, and the remaining signals/channels may follow the reinterpreted TCI state (e.g., changed TCI state).

To support the above-described operation, even when the joint TCI state indication method is applied, the terminal may perform UL beam measurement. In other words, the serving cell may indicate an SRS resource set to the terminal through RRC signaling, and usage of the SRS resource set may be beam management. A reason is that the separate TCI state indication method may be dynamically applied.

### Third Mode

The serving cell may instruct the terminal to perform beam management operations through signaling in an mTRP scenario consisting of two TRPs and/or a scenario consisting of one TRP and one RxP. The scenario consisting of one TRP and one RxP may be assumed, and the beam management operation may be performed based on the assumption. A macro TRP may not support TRP DTX or TRP DRX. In other words, the macro TRP may operate in an always-on state. A small TRP may always operate in an activated state of a TRP DTX pattern or a deactivated state of the TRP DTX pattern. A periodicity and configuration of activation of the TRP DTX pattern (or deactivation of the TRP DRX pattern) for the small TRP may be indicated in two manners. For example, the TRP DTX pattern may be classified into a long TRP DTX pattern and a short TRP DTX pattern. The small TRP may operate based on the short TRP DTX pattern and may subsequently operate based on the long TRP DTX pattern. A difference between the long TRP DTX pattern and the short TRP DTX pattern may be a difference in ratio between an on-duration and an off-duration. For example, an on-duration of the long TRP DTX pattern may be longer than that of the short TRP DTX pattern. Alternatively, the off-duration of the long TRP DTX pattern may be longer than that of the short TRP DTX pattern.

Alternatively, a difference between the long TRP DTX pattern and the short TRP DTX pattern may be a difference in periodicity of an on-duration and an off-duration. For example, a periodicity of an on-duration of the long TRP DTX pattern may be longer than that of an on-duration of the short TRP DTX pattern. Alternatively, the periodicity of the off-duration of the long TRP DTX pattern may be longer than that of the short TRP DTX pattern.

The serving cell may determine a metric for switching (e.g., transitioning) between the long TRP DTX pattern and the short TRP DTX pattern for the small TRP. Switching between the long TRP DTX pattern and the short TRP DTX pattern may be performed based on the metric. In another method, without a separate metric, when a preconfigured condition is satisfied, switching between the long TRP DTX pattern and the short TRP DTX pattern may be performed. When switching between the long TRP DTX pattern and the short TRP DTX pattern occurs, the serving cell may indicate the switching between the long TRP DTX pattern and the short TRP DTX pattern to terminal(s) by using the DCI format 2_A and/or MAC CE. In other words, the DCI format 2_A and/or MAC CE may include information indicating the switching between the long TRP DTX pattern and the short TRP DTX pattern.

According to an SSB transmission periodicity of the small TRP, SSB(s) received from the small TRP during an off-duration of the short TRP DTX pattern may have sufficient quality for beam management at the terminal. According to the SSB transmission periodicity of the small TRP, SSB(s) received from the small TRP during an off-duration of the long TRP DTX pattern may not have sufficient quality for beam management at the terminal. In such a case, in a procedure of beam management (e.g., beam measurement, beam reporting, beam indication), it may be preferable that the terminal performs beam management by applying, to the long TRP DRX pattern, a beam measurement method that is different from a beam measurement method for the short TRP DTX pattern.

In an on-duration of the DTX pattern of the small TRP, the terminal may receive a DL RS (e.g., SSB and/or CSI-RS) from the small TRP and may determine a pathloss by using the DL RS. The terminal may receive a DL RS from the macro TRP and may determine a pathloss by using the DL RS. The terminal may determine a difference between the pathloss for the small TRP and the pathloss for the macro TRP. The difference between the pathloss for the small TRP and the pathloss for the macro TRP may be referred to as a pathloss offset.

In an off-duration of the DTX pattern of the small TRP, the terminal may not receive a DL RS from the small TRP, and therefore it may be difficult to perform UL beam management and/or determine a Tx power applied to UL signals/channels. In an off-duration of the DTX pattern of the small TRP, the terminal may not receive a DL RS from the small TRP.

In a communication system operating in FR1, separate UL beam management may be unnecessary, and a Tx power may be determined to minimize inter-cell interference. The terminal may determine a Tx power applied to UL signals/channels for the macro TRP and a Tx power applied to UL signals/channels for the small TRP. A pathloss for the macro TRP and a pathloss for the small TRP may be different. A pathloss offset between the macro TRP and the small TRP may be reflected to determine the Tx power for the macro TRP and/or the Tx power for the small TRP. The terminal may report the pathloss offset to the serving cell. For example, the terminal may report the pathloss offset to the serving cell by utilizing a power headroom report (PHR) format or separate RRC signaling. The serving cell may indicate the pathloss offset to the terminal by using RRC signaling or a MAC CE.

UL power control for the small TRP may be based on a separate control loop. UL power control for the small TRP may be distinguished from UL power control for the macro TRP.

The terminal may measure the pathloss based on a DL RS (e.g., pathloss (PL) RS) received from the macro TRP, may determine the pathloss for the small TRP by reflecting the measured pathloss and the pathloss offset, and may derive a UL power for the small TRP based on the determined pathloss. The PL RS provided to the terminal may not be changed. In other words, a transmission entity (e.g., the macro TRP or the small TRP) of the PL RS may not be changed depending on the DTX state of the small TRP.

In another exemplary embodiment, the PL RS for pathloss measurement may be changed depending on the state of the DTX pattern of the small TRP. For example, in an on-duration of the DTX pattern of the small TRP, the terminal may receive the PL RS from the small TRP and may determine the pathloss for the small TRP based on the received PL RS. In an off-duration of the DTX pattern of the small TRP, the terminal may receive the PL RS from the macro TRP and may estimate the pathloss for the small TRP based on the received PL RS.

An operation in which the terminal determines a Tx power of UL signals/channels may differ based on the state of the DTX pattern of the small TRP or a DTX mode of the DTX pattern (e.g., whether the short TRP DTX pattern or the long TRP DTX pattern is applied). Therefore, the terminal needs to identify the DTX mode of the small TRP. The serving cell may notify the terminal of information on the DTX mode of the small TRP by using the DCI format 2_A or MAC CE. The DCI format 2_A or MAC CE may include information on the DTX mode of the small TRP.

The small TRP may operate in two or more DTX modes, and one of the two or more DTX modes may be indicated to the terminal. The above-described operation may mean that an additional beam indication method is applied for the terminal. For example, the joint TCI state indication method, the separate TCI state indication method, and/or the additional TCI state indication method may be considered.

The terminal may separately perform UL beam management to apply the separate TCI state indication method or the additional TCI state indication method. In such a case, when the short TRP DTX pattern is applied to the small TRP, UL beam management may be unnecessary, and when the long TRP DTX pattern is applied to the small TRP, UL beam management may be essential because DL RS may not exist.

When the long TRP DTX pattern is applied to the small TRP, the terminal may operate based on default assumptions defined in the technical specifications. A default QCL assumption for a PDSCH, a PUSCH assumption, and/or a PUCCH assumption will be described.

The terminal may apply a default QCL assumption for a PDSCH before receiving RRC signaling related to a UE-specific search space (USS) set. When scheduling DCI does not explicitly include a TCI field, the terminal may apply the default QCL assumption for a PDSCH. When “an RRC connection between the terminal and the serving cell is not established” or when “DCI scrambled by a system information (SI)-RNTI, a paging (P)-RNTI, a multicast channel (MCCH)-RNTI, a group (G)-RNTI, or a temporary cell (TC)-RNTI is received”, the terminal may assume that a QCL relationship is established between a PDSCH DM-RS antenna port and an SSB. Here, qcl-typeC and/or qcl-typeD may be established.

When DCI scrambled by a random access (RA)-RNTI or an MSGB-RNTI is received, the terminal may assume that a QCL relationship is established between a PDSCH DM-RS antenna port and an SSB selected in a RACH procedure.

When a TCI state indicating QCL information of a CORESET DM-RS antenna port is not indicated to the terminal, the terminal may assume that qcl-typeA and/or qcl-typeD is established between a DM-RS antenna port related to PDCCH reception in a CORESET (e.g., CORESET 0) configured by pdcch-ConfigSIB1 included in MIB, a PDSCH DM-RS antenna port, and an SSB.

When “an RRC connection between the terminal and the serving cell is established”, “scheduling DCI does not include a TCI field”, and/or “a time interval (e.g., offset) between a reception time of the DCI and a reception time of a PDSCH scheduled by the DCI is smaller than a preset interval”, the terminal may operate based on the default QCL assumption. The preset interval may be indicated to the terminal by RRC signaling of the base station. For example, timeDurationForQCL may indicate the preset interval. The above-described operation may be applied when a PDSCH DM-RS antenna port in which qcl-typeD is configured exists in at least one TCI state among TCI states configured for the serving cell. The default QCL assumption may mean QCL information provided from a CORESET DM-RS having the smallest index (e.g., controlResourceSetId) among CORESETs associated with a PDCCH received in the most recent slot.

When enableDefaultTCI-StatePerCoresetPoolIndex is configured to the terminal, a PDSCH DM-RS antenna port may be assumed based on QCL information provided from a DM-RS of a CORESET having the lowest index among CORESETs having the same index (e.g., coresetPoolIndex) as a CORESET associated with the PDCCH scheduling the PDSCH.

To summarize the default QCL assumption related to the PDSCH, it may be assumed that the SSB selected in the initial access procedure and the PDSCH DM-RS antenna port have a QCL relationship. Alternatively, when an RRC connection is established between the terminal and the serving cell, when the TCI state is not explicitly indicated to the terminal, or when the first symbol of the PDSCH is allocated at a time in which an Rx beam is not applicable, it may be assumed that the most recently monitored CORESET DM-RS antenna port and the PDSCH DM-RS antenna port have a QCL relationship.

The default QCL assumption for the PUSCH may be applied before signaling (e.g., RRC signaling) indicates a TCI state or an SRS resource indicator (SRI) to the terminal. The terminal may assume that a UL Tx beam applied to a PUSCH scheduled by a DCI format in the initial access procedure, a CG PUSCH, a PUCCH, or an SRS is identical to a UL Tx beam of a PUSCH scheduled by a random access response (RAR) UL grant or a MsgA PUSCH in the initial access procedure.

When the terminal performs RRC connection re-establishment while performing mobility management, an ‘RRC reconfiguration with sync’ may be considered. A TCI state or a TCI-UL state may be indicated to the terminal through RRC signaling, and the terminal may assume a UL Tx beam identical to a UL Tx beam of a received RAR UL grant or a MsgA PUSCH in a random access procedure before applying the indicated TCI state or TCI-UL state.

A PUSCH may be scheduled by a DCI format 0_0. In this case, because the DCI format (e.g., DCI format 0_0) does not include an SRI field, a UL Tx beam applied to the PUSCH may be based on a default QCL assumption. When a PUSCH is scheduled by a DCI format 0_0, the terminal may assume that the same spatial relation is applied to a PUCCH resource having the lowest identifier and the PUSCH. When the PUCCH resource has two spatial relations, the terminal may select a spatial relation corresponding to a lower identifier among the two spatial relations and may apply the selected spatial relation to the UL Tx beam of the PUSCH.

The base station may indicate enableDefaultBeamPL-ForPUSCH0 -0 set to enabled to the terminal through signaling (e.g., RRC signaling). The terminal may identify enableDefaultBeamPL-ForPUSCH0 -0 set to enabled through the signaling of the base station. In this case, when a PUSCH is scheduled by a DCI format 0_0, the terminal may derive a UL Tx beam from a CORESET DM-RS. When a PUCCH resource is not indicated to the terminal in an active UL BWP and a PUSCH is scheduled by a DCI format 0_0, the terminal may determine an RS providing qcl-typeD based on a DM-RS of a CORESET having the lowest index and may apply a UL Tx beam of the PUSCH based on the determined RS. When two TCI states for the CORESET DM-RS are indicated to the terminal, sfnSchemePdcch is indicated to the terminal, and the terminal supports sfn-DefaultUL-BeamSetup, the terminal may apply the UL Tx beam of the PUSCH using a first TCI state among the TCI states.

When summarizing the default QCL assumption related to the PUSCH, if the PUSCH is scheduled by the DCI format 0_0, the terminal may apply a UL Tx beam of one PUCCH resource to a PUSCH DM-RS antenna port, and the one PUCCH resource may be a PUCCH resource having the lowest index in the active UL BWP. When a spatial relation for the PUCCH resource is not indicated to the terminal, the terminal may apply, to a PUSCH DM-RS antenna port, a UL Tx beam corresponding to an RS providing qcl-typeD for a CORESET DM-RS instead of the PUCCH. The index (e.g., identifier) of the CORESET may be the lowest index in the active DL BWP.

A case in which the terminal receives an indication of a PUCCH resource but does not receive indications of spatial relations for all PUCCH resources may occur. In this case, a UL transmission may be scheduled by a DCI format 0_0. In the above situation, the terminal may identify an RS providing qcl-typeD from a DM-RS of the CORESET having the lowest identifier (e.g., the lowest index) and may determine a UL Tx beam of the PUSCH based on the RS. When two TCI states for the CORESET DM-RS are indicated to the terminal, sfnSchemePdcch is configured to the terminal, and the terminal supports sfn-DefaultUL-BeamSetup, the terminal may apply a first TCI state among the two TCI states to the UL Tx beam of the PUSCH.

When dl-OrJointTCI-StateList or TCI-UL-State is indicated to the terminal and two TCI states or two TCI-UL states are configured to the terminal, the terminal may apply a first TCI state among the two TCI states or a first TCI-UL state among the two TCI-UL states to the PUSCH (e.g., the UL Tx beam of the PUSCH) scheduled or activated by the DCI format 0_0.

An SRI may not be used in order to determine the UL Tx beam applied to the PUCCH, and a spatial relation (e.g., UL Tx beam) may be determined by applying QCL information or a TCI state. When PUCCH-related information (e.g., PUCCH-SpatialRelationInfo) is not configured to the terminal or when the terminal performs initial access, a default QCL assumption may be established. When the terminal performs RRC reconfiguration (e.g., RRC reconfiguration with sync) for mobility support and a TCI state or a TCI-UL state is indicated to the terminal, before the TCI state (or the TCI-UL state) indicated to the terminal is applied, the terminal may assume that the UL Tx beam of the PUCCH is identical to the UL Tx beam of the PUSCH scheduled by the RAR UL grant or identical to the UL Tx beam of the MsgA PUSCH.

The terminal may be configured to use one TCI state in dl-OrJointTCI-StateList or one TCI-UL state in ul-TCI-StateList. In this case, the QCL information may be applied to the UL Tx beam of the PUCCH.

When PUCCH-related beam information (e.g., PUCCH-SpatialRelationInfo) is not indicated to the terminal, if a specific condition is satisfied, the terminal may derive a QCL assumption from a CORESET DM-RS and may determine the UL Tx beam of the PUCCH based on the derived QCL assumption. The specific condition may refer to a case in which pathlossReferenceRSs in PUCCH-PowerControl is not indicated to the terminal, enableDefaultBeamPL-ForPUCCH is indicated to the terminal, and PUCCH-SpatialRelationInfo is not indicated to the terminal. When the specific condition is satisfied, the terminal may assume that QCL information is derived from the DM-RS of the CORESET having the lowest identifier in the active DL BWP of the PCell and may determine the spatial relation of the PUCCH based on the derived QCL information. When two or more activated TCI states for the CORESET DM-RS are indicated to the terminal, the terminal may apply a first TCI state among the two or more activated TCI states to the UL Tx beam of the PUCCH.

When summarizing the default QCL assumptions related to the PUCCH, the UL Tx beam for the RS providing qcl-typeD of one CORESET DM-RS may be applied to the PUCCH DM-RS antenna port. The CORESET identifier (e.g., CORESET index) may be the lowest CORESET identifier in the active DL BWP. The terminal may operate based on the default QCL assumption. The above exemplary embodiment may be interpreted as the additional TCI state indication method. The reason is that when an additional TCI state is not indicated to the terminal, the terminal interprets the beam based on the default QCL assumption.

The joint TCI state indication method may be utilized in the macro TRP. The terminal may determine a UL Tx beam to transmit a PUSCH or PUCCH to the small TRP and may apply the default QCL assumption. For the above operation, the terminal may receive a DL RS from the small TRP.

The terminal may derive the UL Tx beam of the PUSCH or the PUCCH using a PUCCH DM-RS transmitted to the small TRP or using a CORESET DM-RS or SSB received from the small TRP. A TCI state or a coresetPoolIndex for the CORESET may be considered for reception from the small TRP. The above exemplary embodiment may be applied even when the long TRP DTX pattern is applied to the small TRP. Even when the long TRP DTX pattern is applied to the small TRP, the small TRP may transmit a minimum DL RS for deriving a UL Tx beam and/or a UL power according to a preset periodicity.

When the long TRP DTX pattern is applied to the small TRP, a DL RS, a PUCCH resource, and/or a CORESET DM-RS may not exist. The terminal may use the lastly monitored (e.g., received) CORESET, but when the long TRP DTX pattern is applied to the small TRP, the CORESET DM-RS referenced by the terminal may be a CORESET DM-RS received considerably earlier. The terminal may not perform UL transmission to the small TRP after a preset time. To support the above operation, a separate timer or a timer associated with the DTX pattern of the small TRP may be configured in the terminal, and the above timer may be associated with the DTX pattern of the small TRP. When the above timer expires, the terminal may not perform UL transmission to the small TRP. When transmission and reception operations between the terminal and the small TRP are performed, a value of the timer may be newly initiated or may be kept pending, whereby an expiration time of the timer may be substantially extended.

### Configured Grant (CG)

Semi-persistent scheduling (SPS) PDSCH, HARQ-ACK for SPS PDSCH, CG PUSCH, periodic PUCCH, semi-persistent PUCCH, periodic SRS, and/or semi-persistent SRS may be considered. For transmission and reception (e.g., continuous transmission and reception) of the above signals/channels, a state of TRP2 (e.g., small TRP) may be changed.

The terminal may not reflect the state of the small TRP. The above operation may mean that the operation of the terminal is not affected by the DCI format 2_A for the continuous transmission and reception of the signals/channels. In an off-duration of the TRP DTX pattern, TRP2 may not transmit a PDSCH, but the terminal may decode a TB by assuming that a PDSCH is received. In this case, the terminal may determine that a NACK for the PDSCH occurs and may transmit the NACK through a PUCCH. In an off-duration of the TRP DRX pattern, TRP2 may not receive a PUSCH, but the terminal may transmit a TB by assuming that a PUSCH is transmitted.

According to the above operation, the number of transmissions of the TB in the MAC layer or the number of transmissions in the RLC layer (or PDCP layer) may increase, but meaningful transmission and reception may not actually occur. To solve the above problem, it may be preferable for the terminal to reflect the state of the small TRP. In an off-duration of the TRP DTX pattern of TRP2, the terminal may determine that a PDSCH is not transmitted from TRP2 and may not decode a TB. In an off-duration of the TRP DRX pattern of TRP2, the terminal may not transmit a PUSCH to TRP2. In other words, in an off-duration of the TRP DRX pattern of TRP2, the terminal may not transmit a PUCCH having a TCI state associated with TRP2. In an on-duration of the TRP DTX pattern, the terminal may receive a PDSCH. In an off-duration of the TRP DRX pattern, the terminal may not transmit a PUCCH including a HARQ-ACK for the PDSCH. Alternatively, in an off-duration of the TRP DRX pattern, the terminal may not transmit a PUCCH including SR. Alternatively, PUCCH transmission may be regarded as an exception regardless of an on-duration or an off-duration of the TRP DRX pattern, and the terminal may transmit a PUCCH including a HARQ-ACK for the PDSCH, and TRP2 (or TRP1) may receive the PUCCH. SR transmission may be regarded as an exception in an on-duration or an off-duration, and the terminal may transmit a PUCCH including SR regardless of an on-duration or an off-duration of the TRP pattern, and TRP2 (or TRP1) may receive the PUCCH.

The terminal may not transmit a PUCCH including a CSI report in an off-duration of the TRP DRX pattern.

### Deferring Transmission

A time resource for a signal or channel scheduled to the terminal may be a valid time resource or an invalid time resource according to a state of the small TRP. The terminal may perform transmission or reception by considering only scheduling DCI. Alternatively, the terminal may perform transmission or reception by reinterpreting the scheduling DCI by considering the DCI format 2_A.

For transmission of a HARQ-ACK of the terminal, information (e.g., field) included in the scheduling DCI may indicate a slot in which a PUCCH is transmitted. A transmission slot of the PUCCH may be indicated by a relative offset with respect to a reception slot of a PDSCH. In a TDD-based communication system, a PUCCH may be valid in a time resource where the PUCCH is transmitted. In other words, PUCCH transmission may not be indicated in a DL symbol or a DL subband. When a PUCCH is repeatedly transmitted, a first time resource for the PUCCH may be valid. PUCCH transmission (e.g., PUCCH retransmission) after the first transmission of the PUCCH may be performed in a valid time resource, and the number of PUCCH transmissions may be maintained. Time resources for the repeated PUCCH transmission may be time resources indicated through signaling (e.g., RRC signaling). The time resources for the repeated PUCCH transmission may be time resources additionally considering a DCI format 2_0 including a slot format indicator (SFI).

The terminal may perform available slot counting based on signaling (e.g., RRC signaling) in order to transmit SRS. The terminal may interpret a DCI format in order to transmit SRS. The DCI format may include an information field for triggering SRS. One trigger state for SRS may be associated with a plurality of SRS resource sets. One SRS resource set may include a time resource for SRS transmission (e.g., a slot offset applied to a time resource of SRS). SRS may be transmitted in a slot to which an offset from a slot in which the DCI format is received is applied. SRS may be transmitted in a time resource derived by a separate offset. In this case, the time resource in which the terminal transmits SRS may be derived by applying an offset indicated for each SRS resource in a slot applied to the SRS resource set. When a separate offset for the SRS resource is not indicated, SRS may be transmitted in the slot applied to the SRS resource set. When SRS cannot be transmitted in a valid SRS resource (e.g., valid time resource), the SRS transmission may be deferred to be performed in a slot after the valid SRS resource. Based on the above exemplary embodiment, a first time resource for SRS transmission and time resource(s) after the first time resource may be determined. The resource in which the SRS can be transmitted may be a time resource indicated through signaling (e.g., RRC signaling). The resource in which the SRS can be transmitted may be a time resource additionally considering a DCI format 2_0 including an SFI.

The terminal may perform available slot counting based on signaling (e.g., RRC signaling) for PUSCH transmission (or SRS transmission). A PUSCH repetition type A may be indicated to the terminal, and the terminal may perform repeated PUSCH transmission. In this case, the number of transmissions for the repeated PUSCH transmission of the terminal may be guaranteed. A reference for determining a PUSCH resource as an invalid resource may be a time resource (e.g., slot pattern) indicated through signaling (e.g., RRC signaling). Alternatively, a reference for determining a PUSCH resource as an invalid resource may be a time resource additionally considering a DCI format 2_0 including an SFI. When an SRS resource is determined as an invalid resource, the terminal may perform SRS transmission several times. In this case, the number of transmissions for the SRS transmission of the terminal may be guaranteed.

When the DCI format 2_A or MAC CE format is applied, the terminal may consider an activated state of the TRP DRX pattern and a deactivated state of the TRP DRX pattern. It may be preferable the terminal transmits a UL signal/channel in the deactivated state of the TRP DRX pattern (e.g., long TRP DRX pattern or short TRP DRX pattern) and/or in an on-duration of the activated state of the TRP DRX pattern (e.g., long TRP DRX pattern or short TRP DRX pattern). The terminal may consider the DCI format 2_A or MAC CE format in order to determine whether to transmit the UL signal or channel. Each of the DCI format 2_A and the MAC CE format may indicate a state of the TRP DTX pattern and a state of the TRP DRX pattern. In the deactivated state of the TRP DRX pattern and/or an on-duration of the activated state of the TRP DRX pattern (e.g., long TRP DRX pattern or short TRP DRX pattern), the terminal may interpret that transmission of the UL signal/channel is allowed. In an off-duration of the activated TRP DTX pattern, the terminal may not perform transmission of the UL signal/channel. The above operation may mean deferring or dropping transmission of the UL signal/channel.

The terminal may determine a resource for the first transmission of the UL signal/channel based on the scheduling DCI. The terminal may determine a resource for the first transmission of the UL signal/channel by considering the activated state of the TRP DRX pattern and the deactivated state of the TRP DRX pattern.

### sDCI-based mTRP

### Beam Indication Mode Switching

The small TRP (e.g., TRP2) may be in the activated state of the DTX pattern or the deactivated state of the DTX pattern. The activated state of the DTX pattern may be interpreted as the activated state of the TRP DTX pattern depending on a context. The deactivated state of the DTX pattern may be interpreted as the deactivated state of the TRP DTX pattern depending on a context. The activated or deactivated state of the TRP DTX pattern may not affect a UL signal/channel transmission operation. The activated or deactivated state of the TRP DTX pattern may affect a DL signal/channel reception operation.

In an off-duration of the activated DTX pattern of the small TRP, the terminal may receive a DL signal/channel from the macro TRP. In the deactivated state of the DTX pattern or an on-duration of the activated DTX pattern of the small TRP, the terminal may receive a DL signal/channel from the macro TRP and the small TRP.

A Tx beam (e.g., TCI state) applied to a UL signal/channel may be determined based on a TCI state indication method (e.g., joint TCI state indication method or separate TCI state indication method). When there is no DL signal or channel received from the small TRP, the separate TCI state indication method (or the additional TCI state indication method) may be applied.

When the state of the TRP DTX pattern (e.g., an on-duration or off-duration of the activated DTX pattern, or the deactivated state of the DTX pattern) is changed or another TRP DTX pattern (e.g., long TRP DTX pattern or short TRP DTX pattern) is activated based on the DCI format 2_A (or DCI format 1_1, MAC CE), the terminal may determine that a beam indication method (e.g., joint TCI state indication method or separate TCI state indication method (e.g., additional TCI state indication method)) is switched. In an on-duration of the activated state of the TRP DTX pattern (or deactivated state of the TRP DTX pattern) or in an activated state of any one TRP DTX pattern (e.g., long TRP DTX pattern or short TRP DTX pattern), the terminal may determine a beam by applying the joint TCI state indication method. In an off-duration of the activated state of the TRP DTX pattern or in an activated state of another TRP DTX pattern (e.g., short TRP DTX pattern or long TRP DTX pattern), the terminal may determine a beam by applying the separate TCI state indication method (e.g., additional TCI state indication method). The terminal may perform a UL beam management procedure in order to apply the separate TCI state indication method (e.g., additional TCI state indication method).

The small TRP (e.g., TRP2) may be in the activated state (e.g., on-duration or off-duration) of the DRX pattern, an activated state of any one DRX pattern (e.g., short DRX pattern or long DRX pattern), or the deactivated state of the DRX pattern. The on-duration or off-duration of the activated state of the DRX pattern may be interpreted as an on-duration or off-duration of the activated state of the TRP DRX pattern depending on a context. The deactivated state of the DRX pattern may be interpreted as the deactivated state of the TRP DRX pattern depending on a context. The activated or deactivated state of the TRP DRX pattern may not affect a DL signal/channel reception operation. The activated or deactivated state of the TRP DRX pattern may affect a UL signal/channel transmission operation.

In an off-duration of the activated DRX pattern of the small TRP, the terminal may transmit a UL signal/channel to the macro TRP. In the activated state (e.g., on-duration) of the DRX pattern of the small TRP, in an activated state of any one DRX pattern (e.g., long DRX pattern or short DRX pattern), or in the deactivated state of the DRX pattern, the terminal may transmit a UL signal/channel to the macro TRP and the small TRP.

When the state of the TRP DTX pattern (e.g., an on-duration or off-duration of the activated state of the DTX pattern, or the deactivated state of the DTX pattern) is changed or another TRP DRX pattern (e.g., long TRP DRX pattern or short TRP DRX pattern) is activated based on the DCI format 2_A (or DCI format 1_1, MAC CE), the terminal may determine that a beam indication method (e.g., joint TCI state indication method or separate TCI state indication method (e.g., additional TCI state indication method)) is switched. In an on-duration of the activated state of the TRP DTX pattern (or deactivated state of the TRP DRX pattern) or in an activated state of any one TRP DTX pattern (e.g., short TRP DTX pattern), the terminal may determine a beam by applying the joint TCI state indication method. In an off-duration of the activated state of the TRP DTX pattern (or deactivated state of the TRP DTX pattern) or an activated state of another TRP DTX pattern (e.g., long TRP DTX pattern), the terminal may determine a beam by applying the separate TCI state indication method (e.g., additional TCI state indication method). Since a TCI for the UL signal/channel may be obtained from the macro TRP, the terminal may not need to perform a separate UL beam management procedure.

### DCI Reinterpretation

A TCI state of a PDSCH received in a slot t and a TCI state of a PUCCH transmitted in a slot t+4 may be indicated by scheduling DCI. The terminal may determine the TCI state of the PDSCH received in the slot t based on the scheduling DCI, and may determine the TCI state of the PUCCH transmitted in the slot t+4 based on the scheduling DCI. The terminal may communicate with the macro TRP and the small TRP. A deactivation of the TRP DTX pattern for the small TRP may be derived from the DCI format 2_A. From the slot t, the DTX pattern of the small TRP may be activated, and from the slot t+1, the DTX pattern of the small TRP may be deactivated.

In the above scenario, the terminal may derive information for interpreting a TCI state (or TCI state group) in order to receive the PDCCH and the PDSCH from a DCI format 1_1. The TCI state applied to the PUCCH may be the TCI state derived from the DCI format 1_1. When the TCI state of the PUCCH is indicated to the terminal as a TCI state for reception at the small TRP, it may be preferable to determine the TCI state by reflecting the deactivated state of the DTX pattern of the small TRP, the activated state (e.g., on-duration or off-duration) of the DTX pattern, and/or an activated state of any one DTX pattern (e.g., short DTX pattern or long DTX pattern).

Based on the DCI format 2_A, a value of TRP selection information (e.g., TCI selection field) may be interpreted as being changed. The terminal may reinterpret the value of the TRP selection information for a signal/channel scheduled by a DL scheduling DCI format (e.g., DCI format 1_1).

For example, when a TCI state group for TRP1 and TRP2 is indicated by the DCI format 1_1 and the TRP selection information set to ‘01’ or ‘11’ is indicated, the terminal may perform an operation of receiving a PDSCH from TRP2 or an operation of transmitting a PUSCH to TRP2.

When the DCI format 2_A indicates an activation (e.g., off-duration) of the TRP DTX pattern of TRP2 or an activation of another TRP DTX pattern (e.g., long TRP DTX pattern), the terminal may determine that a PDSCH cannot be received from TRP2. The above situation may not occur. Alternatively, the terminal may expect to receive a PDSCH from TRP1 and may reinterpret the value of the TRP selection information as ‘10’. The terminal may derive a TCI state associated with TRP1 based on information derived from the TCI state group and may apply the derived TCI state to the reception of the PDSCH.

When the DCI format 2_A indicates the activated state (e.g., off-duration) of the TRP DRX pattern of TRP2 or an activation of another TRP DRX pattern (e.g., long TRP DRX pattern), the terminal may determine that TRP2 does not receive a PUSCH even when the terminal transmits the PUSCH to TRP2. Even in an off-duration of the activated TRP DRX pattern of TRP2, the terminal may transmit a PUSCH by applying a TCI state associated with TRP2. The above situation may not occur. Alternatively, the terminal may expect to transmit a PUSCH to TRP1 and may reinterpret the value of the TRP selection information as ‘10’. The terminal may derive a TCI state associated with TRP1 based on information derived from the TCI state group and may apply the derived TCI state to the transmission of the PUSCH.

The terminal may interpret the TCI state group of the PUCCH based on the above method. The terminal may assume that the activated state (e.g., on-duration or off-duration) of the TRP DRX pattern of TRP2, a type of the activated TRP DRX pattern (e.g., long TRP DRX pattern or short TRP DRX pattern), and/or the deactivated state of the TRP DRX pattern is not reflected. Alternatively, in order to reflect the activated state of the TRP DRX pattern of TRP2, the type of the activated TRP DRX pattern (e.g., long TRP DRX pattern or short TRP DRX pattern), and/or the deactivated state of the TRP DRX pattern, the terminal may reinterpret the value of the TRP selection information derived from the DCI format 1_1 as ‘10’. The terminal may derive a TCI state associated with TRP1 based on information derived from the TCI state group and may apply the derived TCI state to the transmission of the PUCCH.

### mDCI-Based mTRP

When a delay occurs in a backhaul between a serving cell (e.g., base station) and the macro TRP and/or the small TRP or when data capacity of the backhaul is limited, the base station may indicate mDCI-based mTRP communication to the terminal through signaling. The terminal may determine that an mDCI-based mTRP operation is performed based on signaling of the base station.

For mDCI, a CORESET pool index may be configured for each CORESET, and each CORESET may be configured for transmission of each TRP. The terminal may share a TCI state for DL signals/channels and UL signals/channels associated with the same CORESET pool index. Scheduling DCI may not include TRP selection information, and the terminal may derive a TCI state corresponding to one TRP belonging to a TCI state group based on signaling (e.g., RRC signaling) and may ignore a TCI state corresponding to another TRP.

### Beam Indication Mode Switching

The small TRP (e.g., TRP2) may be in the activated state of the DTX pattern or in the deactivated state of the DTX pattern. The activated or deactivated state of the TRP DTX pattern may not affect a UL signal/channel transmission operation. The activated or deactivated state of the TRP DTX pattern may affect a DL signal/channel reception operation.

In an off-duration of the activated state of the DTX pattern of TRP2 or in an activated state of any one DTX pattern (e.g., short DTX pattern or long DTX pattern), the terminal may receive a DL signal/channel from the macro TRP. In the deactivated state of the DTX pattern of the small TRP, an on-duration of the activated state of the DTX pattern, or an activated state of another DTX pattern (e.g., long DTX pattern or short DTX pattern), the terminal may receive a DL signal/channel from the macro TRP and the small TRP.

Since there is no DL signal/channel received from the small TRP, a Tx beam (e.g., TCI state) applied to a UL signal/channel may be determined based on the separate TCI state indication method.

When the state of the TRP DTX pattern (e.g., an on-duration or off-duration of the activated state of the DTX pattern, or the deactivated state of the DTX pattern) is changed or another TRP DTX pattern (e.g., long TRP DTX pattern or short TRP DTX pattern) is activated based on the DCI format 2_A (or DCI format 1_1, MAC CE), the terminal may determine that a beam indication method (e.g., joint TCI state indication method or separate TCI state indication method (e.g., additional TCI state indication method)) is switched. In an on-duration of the activated state of the TRP DTX pattern (or deactivated state of the TRP DTX pattern) or in an activated state of any one TRP DTX pattern (e.g., long TRP DTX pattern or short TRP DTX pattern), the terminal may determine a beam by applying the joint TCI state indication method. In an off-duration of the activated state of the TRP DTX pattern or an activated state of another TRP DTX pattern (e.g., long TRP DTX pattern or short TRP DTX pattern), the terminal may determine a beam by applying the separate TCI state indication method (e.g., additional TCI state indication method). The terminal may perform a UL beam management procedure in order to apply the separate TCI state indication method (e.g., additional TCI state indication method).

The small TRP (e.g., TRP2) may be in the activated state (e.g., on-duration or off-duration) of the DRX pattern, in an activated state of any one DRX pattern, or in the deactivated state of the DRX pattern. The activated or deactivated state of the TRP DRX pattern may not affect a DL signal/channel reception operation. The activated or deactivated state of the TRP DRX pattern may affect a UL signal/channel transmission operation.

In an off-duration of the activated state of the DRX pattern of the small TRP, the terminal may transmit a UL signal/channel to the macro TRP. In an on-duration of the activated state of the DRX pattern of the small TRP, in an activated state of another DRX pattern, or in the deactivated state of the DRX pattern, the terminal may transmit a UL signal/channel to the macro TRP and the small TRP.

When the state of the TRP DTX pattern (e.g., an on-duration or off-duration of the activated state of the DTX pattern, or the deactivated state of the DTX pattern) is changed or another TRP DTX pattern (e.g., long TRP DRX pattern or short TRP DRX pattern) is activated based on the DCI format 2_A (or DCI format 1_1, MAC CE), the terminal may determine that a beam indication method (e.g., joint TCI state indication method or separate TCI state indication method (e.g., additional TCI state indication method)) is switched. In an on-duration of the activated state of the TRP DTX pattern (or deactivated state of the TRP DTX pattern) or in an activated state of any one TRP DTX pattern (e.g., short TRP DTX pattern), the terminal may determine a beam by applying the joint TCI state indication method. In an off-duration of the activated state of the TRP DTX pattern (or deactivated state of the TRP DTX pattern) or an activated state of another TRP DTX pattern (e.g., activated state of a long TRP DTX pattern), the terminal may determine a beam by applying the separate TCI state indication method (e.g., additional TCI state indication method). Since a TCI for the UL signal/channel may be obtained from the macro TRP, the terminal may not need to perform a separate UL beam management procedure.

### DCI Reinterpretation

A TCI state of a PDSCH received in a slot t and a TCI state of a PUCCH transmitted in a slot t+4 may be indicated by scheduling DCI. The terminal may determine the TCI state of the PDSCH received in the slot t based on the scheduling DCI, and may determine the TCI state of the PUCCH transmitted in the slot t+4 based on the scheduling DCI. The terminal may communicate with the macro TRP and the small TRP. A deactivation of a TRP DTX pattern for the small TRP may be derived from the DCI format 2_A. From the slot t, the DTX pattern of the small TRP may be activated, and from the slot t+1, the DTX pattern of the small TRP may be deactivated.

In the above scenario, the terminal may derive information for interpreting a TCI state (or TCI state group) in order to receive the PDCCH and the PDSCH from a DCI format 1_1. The TCI state applied to the PUCCH may be the TCI state derived from the DCI format 1_1. When the TCI state of the PUCCH is indicated to the terminal as a TCI state for reception at the small TRP, it may be preferable to determine the TCI state by reflecting the deactivated state of the DTX pattern of the small TRP, an on-duration or off-duration of the activated state of the DTX pattern, and/or an activated state of any one DTX pattern.

Based on the DCI format 2_A, a value of TRP selection information (e.g., TCI selection field) may be interpreted as being indicated. In mDCI-based mTRP communication, the DCI format 1_1 may not include TCI information for a signal/channel scheduled by the DCI format 1_1.This is because a CORESET pool index is indicated to the terminal through RRC signaling, and the serving cell may perform beam management and may indicate a TCI state.

When the DCI format 2_A is received, the terminal may reflect a value of TRP selection information based on the deactivated state (or an on-duration or off-duration of the activated DTX pattern) of the DTX pattern of the small TRP (e.g., TRP2) or the deactivated state of the DRX pattern (or an on-duration or off-duration of the activated DRX pattern). In an off-duration of the DTX activated state of the small TRP, the terminal may not receive a DL signal/channel from the small TRP. In an off-duration of the DRX activated state of the small TRP, the terminal may not transmit a UL signal/channel to the small TRP. The terminal may perform the above operations in the same manner as in the exemplary embodiment in which the TRP selection information is applied.

When a TCI state group is indicated to the small TRP, an on-duration or off-duration of the activation of the DTX pattern indicated by the DCI format 2_A (or deactivation of the DTX pattern) or an on-duration or off-duration of the activation of the DRX pattern (or deactivation of the DRX pattern) indicated by the DCI format 2_A may mean that a TRP performing a transmission operation of the PDCCH and/or the PDSCH or a reception operation of the PUCCH is changed. The terminal may transmit and receive a signal/channel with the macro TRP instead of the small TRP. The terminal may apply information derived from the DCI format 2_A as TRP selection information and may determine that the TRP is changed. When the serving cell indicates two TRPs to the terminal, this may be interpreted as that a bit corresponding to the TRP selection information is toggled.

The above operation may mean that a transmission operation for a TRP is cancelled. The terminal may reflect activation of the TRP DTX pattern, on-duration or off-duration of the activated TRP DTX pattern, or activation of the TRP DRX pattern while transmitting and receiving the PDCCH, the PDSCH, and/or the PUCCH. In this case, the terminal may not perform at least one of a transmission or reception operation of the PDCCH, the PDSCH, or the PUCCH.

When the DCI format 2_A indicates the activated state of the TRP DTX pattern of TRP2 or indicates an off-duration of the TRP DTX pattern, the terminal may determine that a PDSCH cannot be received from TRP2. The above situation may not occur. Alternatively, the terminal may expect to receive a PDSCH from TRP1. Therefore, the terminal may derive a TCI state associated with TRP1 based on information derived from the TCI state group and may apply the derived TCI state to the reception of the PDSCH.

When the DCI format 2_A indicates the activated state of the TRP DRX pattern of TRP2 or indicates an off-duration of the TRP DRX pattern of TRP2, the terminal may determine that TRP2 does not receive a PUSCH even when the terminal transmits the PUSCH to TRP2. Even in an off-duration of the activated TRP DRX pattern of TRP2, the terminal may transmit a PUSCH by applying a TCI state associated with TRP2. The above situation may not occur. Alternatively, the terminal may expect to transmit a PUSCH to TRP1. Therefore, the terminal may derive a TCI state associated with TRP1 based on information derived from the TCI state group and may apply the derived TCI state to transmission of the PUSCH.

The terminal may apply the same method to a TCI state group of a PUCCH. The terminal may assume that the terminal does not reflect the activated state of the TRP DRX pattern of TRP2, an on-duration or off-duration of the activated state of the TRP DRX pattern (or the deactivated state of the TRP DRX pattern), and/or a type of the activated TRP DRX pattern (e.g., long TRP DRX pattern or short TRP DRX pattern). Alternatively, in order to reflect the activated state of the TRP DRX pattern of TRP2, an on-duration or off-duration of the activated state of the TRP DRX pattern (or the deactivated state of the TRP DRX pattern), and/or the type of the activated TRP DRX pattern (e.g., long TRP DRX pattern or short TRP DRX pattern), the terminal may derive a TCI state associated with TRP1 based on information derived from the TCI state group and may apply the derived TCI state to transmission of the PUCCH.

### Calibration Reporting

When a TCI state is indicated to the terminal, an RS providing qcl-typeA and an RS providing qcl-typeD may be configured. When a TCI state group is indicated to the terminal, two TCI states may be interpreted as being indicated to the terminal. The terminal may measure beams. For example, the terminal may measure L1-RSRP (or L1-SINR) by using the RS providing qcl-typeD (e.g., qcl-typeD source RS, qcl-typeD RS). The qcl-typeD RS may be a CSI-RS or an SSB for beam management.

The serving cell may perform a CJT operation by using two or more TRPs. For the CJT operation, time synchronization and frequency synchronization between the TRPs need to be sufficiently matched. It may be preferable that a communication node (e.g., the terminal, the serving cell) reflects separate measurement values for time synchronization and/or frequency synchronization. Separate measurement may be performed at the terminal or at the serving cell.

### UE-Based Measurement

The terminal may measure a DL RS transmitted by each TRP belonging to the serving cell. When the macro TRP and the small TRP operate, a TCI state for the macro TRP and a TCI state for the small TRP may be indicated independently to the terminal. The terminal may derive a qcl-typeD RS for each TCI state and may perform beam measurement by using the derived qcl-typeD RS.

For performing a CJT operation, at least one of a time delay, a frequency delay, or a phase offset may be compensated. The terminal may utilize a CSI-RS or an SSB for tracking in order to measure the time delay (e.g., time offset). The terminal may utilize a CSI-RS or an SSB in order to measure the frequency delay (e.g., frequency offset). The terminal may utilize a CSI-RS or an SSB in order to measure the phase offset. Compensation of the time delay for performing the CJT operation may be referred to as cjtc-Td compensation. Compensation of the frequency delay for performing the CJT operation may be referred to as cjtc-F compensation. Compensation of the phase offset for performing the CJT operation may be referred to as cjtc-P compensation.

The terminal may receive TCI information and TRP selection information for a TCI state group and may receive a PDSCH from two TRPs. The two TRPs may perform a CJT operation. Scheduling DCI may include separate information (e.g., separate field), and an operation for cjtc-Td compensation, cjtc-F compensation, and/or cjtc-P compensation may be performed based on the separate information.

For example, the macro TRP may be a TRP serving as a reference (e.g., reference TRP). The operation for cjtc-Td compensation, cjtc-F compensation, and/or cjtc-P compensation for the small TRP may be performed at the terminal. The scheduling DCI may include new information (e.g., new field), and based on the new information, the terminal may additionally perform the operation for cjtc-Td compensation, cjtc-F compensation, and/or cjtc-P compensation on demodulation information derived from qcl-typeA RSs in a TCI state related to the small TRP. The new information may be represented by one bit. In order to indicate each of cjtc-Td compensation, cjtc-F compensation, and cjtc-P compensation, the new information may be represented by a plurality of bits. Alternatively, the operation for cjtc-Td compensation and cjtc-F compensation may be represented by one bit, and the operation for cjtc-P compensation may be represented by another bit. Alternatively, the terminal may derive an interpretation method of the information (e.g., field) based on information indicated through signaling (e.g., RRC signaling).

For example, when the TCI selection information is set to 11, the terminal may assume that a PDSCH is received based on CJT and may perform at least one of cjtc-Td compensation, cjtc-F compensation, or cjtc-P compensation. In other words, the terminal may not perform at least one of cjtc-Td compensation, cjtc-F compensation, or cjtc-P compensation.

For a CSI-RS for beam measurement and a CSI-RS for tracking, some symbols or some resource elements (REs) may be shared. The terminal may utilize the CSI-RS for beam measurement in order to perform cjtc-Td compensation, cjtc-F compensation, and/or cjtc-P compensation based on signaling (e.g., RRC signaling). The CSI-RS may be a qcl-typeA RS or a qcl-typeD RS configuring a TCI state. The terminal may obtain at least one of cjtc-Td, cjtc-F, or cjtc-P by comparing qcl-typeA RSs or qcl-typeD RSs. The terminal may report cjtc-Td, cjtc-F, and/or cjtc-P to the serving cell.

### gNB-Based Measurement

The terminal may perform beam management or antenna switching for an SRS transmitted in an SRS resource set. The serving cell may obtain UL CSI by using an SRS received from the terminal. Since a Tx chain and an Rx chain at the terminal do not always correspond to each other, a correspondence relationship between the Tx chain and the Rx chain may be indicated through separate RRC signaling.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, transmission and reception point (TRP) discontinuous transmission (DTX) configuration information;
receiving, from the base station, activation information indicating activation of a TRP DTX operation based on the TRP DTX configuration information; and
performing communication with one or more TRPs associated with the base station based on the TRP DTX operation being activated.

2. The method of claim 1, wherein the activation information indicating the activation of the TRP DTX operation is included in a medium access control (MAC) control element (CE) or first downlink control information (DCI) received from the base station.

3. The method of claim 1, further comprising:
receiving, from the base station, deactivation information indicating deactivation of the TRP DTX operation; and
performing communication with the one or more TRPs associated with the base station based on the TRP DTX operation being deactivated.

4. The method of claim 1, further comprising:
receiving, from the base station, second DCI scheduling downlink (DL) transmission;
determining at least one TRP for performing the DL transmission based on TRP indication information included in the second DCI and a TRP associated with the activated TRP DTX operation; and
receiving the DL transmission from the at least one TRP associated with the base station.

5. The method of claim 1, further comprising:
receiving, from the base station, second DCI scheduling DL transmission;
based on the DL transmission being performed before an application time of the activation information, determining at least one TRP for performing the DL transmission based on information indicating activation or deactivation of the TRP DTX operation received before the activation information and based on TRP indication information included in the second DCI; and
receiving the DL transmission from the at least one TRP associated with the base station.

6. The method of claim 1, further comprising:
receiving, from the base station, second DCI scheduling DL transmission;
determining at least one TRP for performing the DL transmission based on TRP indication information included in the second DCI regardless of whether the TRP DTX operation is activated; and
receiving the DL transmission from the at least one TRP associated with the base station.

7. The method of claim 1, further comprising: receiving, from the base station, information indicating switching of a TCI state indication scheme,
wherein the TCI state indication scheme is a joint TCI state indication scheme or a separate TCI state indication scheme.

8. The method of claim 1, further comprising: receiving, from the base station, information indicating that dynamic switching of a TCI state indication scheme is enabled,
wherein the TCI state indication scheme is switched based on a state of the TRP DTX operation being changed to an activated state or a deactivated state, and the TCI state indication scheme is a joint TCI state indication scheme or a separate TCI state indication scheme.

9. The method of claim 8, wherein the joint TCI state indication scheme is used based on the state of the TRP DTX operation being the activated state, and the separate TCI state indication scheme is used based on the state of the TRP DTX operation being the deactivated state.

10. The method of claim 1, further comprising:
receiving, from the base station, TRP discontinuous reception (DRX) configuration information;
receiving, from the base station, activation information indicating activation of a TRP DRX operation based on the TRP DRX configuration information; and
performing communication with at least one TRP associated with the base station based on the TRP DRX operation being activated.

11. A terminal comprising at least one processor, wherein the at least one processor causes the terminal to perform:
receiving, from a base station, transmission and reception point (TRP) discontinuous transmission (DTX) configuration information;
receiving, from the base station, activation information indicating activation of a TRP DTX operation based on the TRP DTX configuration information; and
performing communication with one or more TRPs associated with the base station based on the TRP DTX operation being activated.

12. The terminal of claim 11, wherein the activation information indicating the activation of the TRP DTX operation is included in a medium access control (MAC) control element (CE) or first downlink control information (DCI) received from the base station.

13. The terminal of claim 11, wherein the at least one processor further causes the terminal to perform:
receiving, from the base station, deactivation information indicating deactivation of the TRP DTX operation; and
performing communication with the one or more TRPs associated with the base station based on the TRP DTX operation being deactivated.

14. The terminal of claim 11, wherein the at least one processor further causes the terminal to perform:
receiving, from the base station, second DCI scheduling downlink (DL) transmission;
determining at least one TRP for performing the DL transmission based on TRP indication information included in the second DCI and a TRP associated with the activated TRP DTX operation; and
receiving the DL transmission from the at least one TRP associated with the base station.

15. The terminal of claim 11, wherein the at least one processor further causes the terminal to perform:
receiving, from the base station, second DCI scheduling DL transmission;
based on the DL transmission being performed before an application time of the activation information, determining at least one TRP for performing the DL transmission based on information indicating activation or deactivation of the TRP DTX operation received before the activation information and based on TRP indication information included in the second DCI; and
receiving the DL transmission from the at least one TRP associated with the base station.

16. The terminal of claim 11, wherein the at least one processor further causes the terminal to perform:
receiving, from the base station, second DCI scheduling DL transmission;
determining at least one TRP for performing the DL transmission based on TRP indication information included in the second DCI regardless of whether the TRP DTX operation is activated; and
receiving the DL transmission from the at least one TRP associated with the base station.

17. The terminal of claim 11, wherein the at least one processor further causes the terminal to perform: receiving, from the base station, information indicating switching of a TCI state indication scheme,
wherein the TCI state indication scheme is a joint TCI state indication scheme or a separate TCI state indication scheme.

18. The terminal of claim 11, wherein the at least one processor further causes the terminal to perform: receiving, from the base station, information indicating that dynamic switching of a TCI state indication scheme is enabled,
wherein the TCI state indication scheme is switched based on a state of the TRP DTX operation being changed to an activated state or a deactivated state, and the TCI state indication scheme is a joint TCI state indication scheme or a separate TCI state indication scheme.

19. The terminal of claim 18, wherein the joint TCI state indication scheme is used based on the state of the TRP DTX operation being the activated state, and the separate TCI state indication scheme is used based on the state of the TRP DTX operation being the deactivated state.

20. The terminal of claim 11, wherein the at least one processor further causes the terminal to perform:
receiving, from the base station, TRP discontinuous reception (DRX) configuration information;
receiving, from the base station, activation information indicating activation of a TRP DRX operation based on the TRP DRX configuration information; and
performing communication with at least one TRP associated with the base station based on the TRP DRX operation being activated.
